(19) United States
(12) Patent Application Publication
(10) Pub. No.: US 2026/0279010 A1
(43) Pub. Date: Sep. 17, 2026

(54) Laser-less, No Emission Range Finding Artificial Intelligence Device and Methods

(71) Applicant: Evrio, Inc., Santa Clara, CA (US)

(72) Inventors: Kendyl A. Roman, Sunnyvale, CA (US); John Livacich, Los Gatos, CA (US)

(21) Appl. No.: 19/676,611

(22) Filed: May 13, 2026

Related U.S. Application Data
(63) Continuation-in-part of application No. 18/635,003, filed on Apr. 15, 2024, now Pat. No. 12,664,672.
Application No. 18/635,003 is a continuation-in-part of application No. 18/431,980, filed on Feb. 4, 2024.

(51) Int. Cl. G06V 10/764; F41G 3/08; G01C 3/08; G06T 7/50; G06V 10/10; G06V 10/147; G06V 10/82; G06V 20/58; G06V 40/10

(52) U.S. Cl. CPC G06V 10/764; F41G 3/08; G01C 3/08; G06T 7/50; G06V 10/147; G06V 10/17; G06V 10/82; G06V 20/58; G06V 40/10; G06V 2201/07; G06V 2201/08

(57) ABSTRACT

Systems and methods for recognizing objects, such as string support rods, birds, mammals, such as deer or elk, or vehicles, such as trucks or tanks, each object type having a known size, and to recognize the distance to each object. For field use, embodiments comprise a trained AI model embedded in a handheld or portable hand-carried device, providing a laser-less, no emission range finding device, such as smart rifle scopes, handheld rangefinders, smart binoculars, smart phones and tablets, the device used to select a target under a crosshair, calculate a distance to the target, and display a distance adjusted aiming point. Methods include using complex machine learning models to determine an object type and to classify additional details so that an accurate known size for an animal or vehicle is determined, and then faster detectors are used to provide realtime distance calculations.

### CROSS-REFERENCE TO RELATED APPLICATIONS

This application is a continuation-in-part of co-pending U.S. patent application Ser. No. 18/635,003, filed Apr. 15, 2024, which is a continuation-in-part of co-pending U.S. patent application Ser. No. 18/431,980, filed Feb. 4, 2024.

### PRIOR ART

### Firing Device and Projectiles

Firing devices such as bows, crossbows, rifles, pistols, other guns, and artillery have been used for sport, hunting, law enforcement, and military. Each firing device is used to launch a projectile such as an arrow, dart, bullet, ball, or explosive shell along a projectile trajectory.

FIG. 1A shows a user (in this case, an archer) 100 with a bow 102 with a bow sight 110 and an arrow 104. The bow sight 110 comprises pins adjusted e.g., for twenty yards, forty yards, and sixty yards, namely a twenty-yard pin, a forty-yard pin, and a sixty-yard pin, respectively. The user 100 has a rangefinder 6.

FIG. 1B shows a rifle 300 with a rifle scope 302. Rifle balls and/or bullets are typically shot from a gun using the arms to aim and sight by aligning the gun sights or gun scope reticle with the target.

Artillery balls and shells are typically shot by adjusting the aim mechanically.

Arrows, spears, balls, bullets, and shells when fired follow a ballistic trajectory. Such projectiles, which are not self-propelled, move through air according to a generally parabolic curve due primarily to the effects of gravity.

The actual projectile trajectory path is not a perfect parabola in a plane due to many factors, such as air drag and lift, crosswind, head wind, tail wind, spin drift, and Coriolis effect. Each bullet type has a different weight and shape which affects the ballistic trajectory. Ballistic coefficients can be determined of each bullet. Drag is affected by environmental factors such as temperature, humidity, and barometric pressure.

The Army Research Laboratory published Wind Drift of Projectiles: A Ballistics Tutorial, ARL-TR-1124, by Herbert A. Leupold, October 1996.

Let's Code Physics, Projectile Motion 12—Drag and Wind teaches programming models for drag and wind on projectiles. Source code is available at the letscodephysics Google Site (Let's Code Physics/projectile motion/12 3D projectile motion—football field goal—w wind.py).

Rifle and bow scopes conventionally have been fitted with reticles of different forms. Some have horizontal and vertical crosshairs. These reticles are fixed in that the display does not change based on range information. Also, these reticles indicate the approximate hold-over position in that they are positioned under the center of the scope, i.e., below where the crosshairs intersect. They are not necessarily precise, for example, for a specific bow and archer or for a specific rifle and cartridge but are approximation for the general case.

### Smart Devices

Hunters and other firearm and bow users commonly utilize handheld rangefinders (see device 6 in FIG. 1A) to determine ranges to targets. Generally, handheld rangefinders utilize lasers to acquire ranges for display to a user. Utilizing the displayed ranges, the user makes sighting corrections to facilitate accurate shooting. Handheld rangefinders, telescope sights, and other optical devices typically comprise a laser range sensor and an inclinometer.

Our U.S. Pat. No. 9,057,587, issued Jun. 16, 2015, and U.S. Pat. No. 9,068,795, issued Jun. 30, 2015, both included by reference, disclose and claim a smart rangefinders which: a) provide an aiming point; b) provide a digital rangefinder having a video camera and high-resolution digital display; and c) displays an aiming point, corrected for range and wind effect anywhere on the high-resolution display.

These patents also disclose the use of a smart phone, such as an iPhone, as a display for a digital rangefinder.

### RADAR, Light Detecting and Ranging (LIDAR) and Other Emission Technologies

Similar, to RADAR, Light Detection and Ranging (LIDAR) emits light and detects reflected light to determine range to objects.

Laser, radar and lidar are commonly used in automated cruise control, such as Toyota Intelligent Adaptive Cruise Control, and in fully autonomous self-driving vehicles, such as Waymo robotaxi or Aurora Driver cars and Aurora Horizon semi-trucks (18-wheeler freight trucks).

### Artificial Intelligence Advances

The U.S. Defense Advanced Research Projects Agency (DARPA) funded the Cognitive Assistant that Learns and Organizes (CALO) project for five years from 2003 to 2008. CALO brought together over 300 researchers from 25 of the top university and commercial research institutions. Software and documentation are available on the PAL website: https://pal.sri.com.

Several AI technologies have spun off from the CALO work, including, for example, Apple's Siri speech recognition, analysis, and speech synthesis.

In October 2006, Intel released version 2 of Open Source Computer Vision Library (OpenCV 2). In August 2012, opencv.org began providing support for OpenCV. Applications for OpenCV include object detection and facial recognition systems. Open source code repositories are available on github.com e.g., opencv/opencv.

In 2013, NVIDIA introduced the Tegra 4. With NVIDIA GPU-accelerated deep learning frameworks, researchers and data scientists can significantly speed up deep learning training that could otherwise take days and weeks to just hours and days. When models are ready for deployment, developers can rely on GPU-accelerated inference platforms for the cloud, embedded device, or self-driving cars, to deliver high-performance, low-latency inference for the most computationally-intensive deep neural networks. https://www.nvidia.com/en-us/glossary/deep-learning/.

In June 2014, Facebook AI Research in Menlo Park, CA, published DeepFace: Closing the Gap to Human-Level Performance in Face Verification. DeepFace discloses the use of a four-stage pipeline, comprising: detect, align, represent, and classify. In its deep learning model, the representation stage uses a nine-layer deep neural network. The paper discloses an architecture comprising a front-end of a single convolution-pooling-convolution filtering on the rectified input, followed by three locally-connected layers and two fully-connected layers.

Images are aligned by detecting 6 initial fiducial points inside the detection crop (bounding rectangle) centered at the center of the eyes, tip of the nose and mouth locations. The detected face is scaled, rotated, and translated. Additional fiducial points are identified in the 2D-aligned crop. The image is 3D aligned by transforming Delaunay triangulation derived from the 67 fiducial points. The 3D-aligned image is given to the first layer of a large deep neural network.

As explained by Sefik Ilkin Serengil, the DeepFace deep learning model is a layered convolutional neural network. Each layer is named with a letter and number. The number refers to the index from 1 to 8 and letter states the type of layer. C refers to convolutional layer, M refers to max pooling, L refers to locally connected layer and F refers to fully connected layer. https://sefiks.com/2020/02/17/face-recognition-with-facebook-deepface-in-keras

OpenFace is open source code. https://github.com/cmusatyalab/openface

OpenFace includes the FaceBook neural network source code. https://github.com/facebookarchive/fbnn

In December 2014, Baidu Research's Silicon Valley AI Lab, published Deep Speech: Scaling up end-to-end speech recognition. Deep Speech trained a large recurrent neural network (RNN) using multiple GPUs and thousands of hours of data. The structure of the RNN model is disclosed in the paper.

Cornell University's Cornell Lab of Ornithology, Merlin project was funded by the Natural Science Foundation. Photo ID, released Nov. 30, 2017, uses computer vision technology, developed as part of Dr. Grant Van Horn's doctoral work at Caltech, to identify birds in photos. Sound ID, released Jun. 23, 2021, learned to recognize the vocalizations of different bird species. Sound ID was trained on audio recordings that are first converted to visual representations (spectrograms), then analyzed using computer vision tools similar to those of Photo ID. Both Photo ID and Sound ID run on smart phones, such as the Apple iPhone. https://merlin.allaboutbirds.org

Grant Van Horn's PhD thesis is entitled Towards a Visipedia: Combining Computer Vision and Communities of Experts, and details recent advances in the use of deep convolutional neural networks in image analysis.

U.S. Pat. No. 11,140,312 was filed by Swarovski-Optik Jul. 17, 2020 (Swarovski '312). U.S. Patent Application 2023/0283882 published Sep. 7, 2023 (Swarovski '882). Both disclose a smart binocular.

FIG. 2 shows monocular 410 comprising a housing 20 supporting an eyepiece 22, a lens 24, an input, an operating button, 32. The components inside the housing 20 comprise: computing element 16, memory 18, wireless communications 19, image sensor (digital camera) 25, audio sensor 29. Swarovski claims require several other elements. Swarovski discloses using the wireless communications 19 to communicate with a smart phone, such as an iphone 11 (not shown) having a high-resolution, touch screen display 31 (not shown). While Swarovski '312 suggests that the smart phone 11 separately executes a mobile app which can recognize an image of a bird, it does not disclose a deep learning model running on the computing element 16 of the monocular 410. The type of bird is recognized by means of a remote image database and an image recognition algorithm. Further, Swarovski '312 discloses using the operating button 32 to start the image capture for object recognition, object detection, and object classification to be executed on the smart phone 11.

In January 2024, Swarovski Optik announced smart binoculars, namely, AX Visio 10×32 binoculars, comprising a neural processing unit (NPU) for object recognition processing, which identifies over 9,000 species of birds and mammals using Merlin Photo ID and Sound ID image recognition technology.

In January 2024, Apple unveiled chips having capabilities to run generative AI, for example, supporting billions of data parameters. The S9 chip allows Siri to access and log data without connecting to the Internet. The A17 Pro chip in the iPhone 15 comprises a neural engine which is twice as fast as previous generations. These advances will allow AI models to run directly on iPhones.

Machine learning and object detection can be implemented in different ways. For example, there are algorithmic object detectors, e.g., using Viola-Jones, HOG, SVM, SSD approaches, and there are deep learning object detectors, e.g., using Deep Neural Networks (DNN) including Convolutional Neural Networks (CNN) such as DeepFace, Dlib (Max Margin Object Detection) and YOLO.

Thus, the machine learning models for recognizing and characterizing audio and images, as well as source code for implementing them, GPU systems for learning, and handheld devices for operating those machine learning models are well known in the art.

### Windage and Elevation

For hundreds of years, hunters and soldiers have learned the mantra “Windage and Elevation.”

However, there has been a long felt need to be able to accurately recognize the winds impact on a projectile and to quickly and dynamically make adjustments despite constant changing, difficult to interpret changes in the wind. Wind adjustment has been largely guesswork.

Until now accurate wind recognition has been the “Holy Grail” sought after by the industry.

What is needed is a device and methods for recognizing wind along a projectile trajectory path so that a user can accurately aim and hit a desired target regardless of the wind speed and direction at different points along the path. Further, what is needed is an indication that wind currently is in a likely sustained favorable state for a brief period of time, such that a user has time to aim and fire.

The grandparent application addresses the need for accurate wind recognition.

Our patented Flight Path® technology (disclosed, for example, in U.S. Pat. No. 9,057,587 referenced above) currently available in Leupold RX-FullDraw 5 and RX-1400i True Ballistic Range/Wind (TBR/W) Gen 2, does an excellent job of handling elevation by providing an aiming point corrected for shoot angle, distance, and ballistics along a vertical plane including the line of sight to a desired target.

However, laser range finding devices have disadvantages: first, laser-based range finding devices must emit laser light in order to operate; second, the laser emissions require electrical power; and third, the laser emission, detection, and analysis require specialized hardware devices, lenses, and processing power.

Laser, radar, or lidar emissions are detectable by a target. Law enforcement and military use laser and other emissions to detect range to a target. However, devices which detect laser or other emissions are available and are used by law enforcement and military targets to be alert, to put up shields, or to move away from the projectile path. Even worse, laser beams can be tracked precisely back to the source and the target can use that information to accurately return fire.

Handheld range finding devices are battery powered. Batteries add weight, cost, and replacement and waterproofing challenges to handheld range finding devices. Reducing power consumption allows for simpler, lower cost products.

Specialized laser hardware devices and lenses contribute to the cost, size, and weight of the laser-based range finder.

Thus, there has been a long felt need to be able to accurately recognize the distance to a target without emitting a laser beam or making other detectable emissions.

What is needed is a device and methods for recognizing distance to a target without emitting a laser beam and to accurately aim and hit a desired target.

### BACKGROUND OF THE INVENTION

The grandparent invention relates to detection of wind, in particular the detection of wind that affects a projectile trajectory path to a desired target, including the use of artificial intelligence (AI) to observe a string supported by flexible rods, positioned along a segment of the projectile trajectory path, and to recognize the wind effect on the object.

The present invention relates to the use of AI in a handheld or portable hand-carried device to observe objects, such string support rods, birds, mammals, such as deer or elk, or vehicles, such as trucks or tanks, each object type having a known size, and to recognize the distance to each object.

The AI is embedded in an AI device having an image sensor and optional laser rangefinder for training the AI. The present invention also relates to devices such as smart rifle scope, handheld rangefinders, smart binoculars, smart phones, and smart tablets which comprise a trained AI, the device is used to select a target, determine the predicted distance to the target, and display a distance adjusted aiming point.

### SUMMARY OF THE INVENTION

The present invention solves the above-described problems and provides a distinct advance in the art of AI devices visually recognizing distance to a target object.

The present invention provides devices and methods for recognizing distance to a desired target without using a laser or other emission. The present invention also identifies and displays the type of object that is targeted, based on a magnified image of the target object. Such information facilitates accurate, effective, and safe firing device use by providing an identification of the target object and an aiming point.

The system further comprises a computing element, a memory, a display, at least one image sensor and at least one lens with a known magnification. The system captures a magnified digital image of a target object, recognizes the type of object, and calculates a preliminary distance to the target based on a known size of the object type and the known magnification of the digital image. The machine learning model operates on the computing element and memory and calculates an estimated distance. A more accurate distance is calculated when the target is classified as a specific species, gender, and maturity, or as a specific make and model of vehicle.

In some embodiments, the classifications such as specific species of animal or specific make and model of vehicle are shown on the display. The user views the classifications on the display and is able to confirm the accuracy of those classifications and thus confirm the accuracy of the final distance determination.

Machine learning models may be algorithmic or deep neural networks. Different object detectors, shape predictors, and classifiers may be implemented with different machine learning models. Some models may require less computing power and neural processors, allowing for devices that are battery operated and which provide real time distance displays.

In some embodiments, the computing element determines a bounding rectangle in the digital image which includes the target object, and crops the digital image based on the bounding rectangle.

In some embodiments, the computing element determines a plurality of fiducial points inside the bounding rectangle based on the object type.

In some embodiments, the computing element performs a 2D or 3D alignment of the target object based on the fiducial points.

In some embodiments, the computing element recognizes a top fiducial point and a bottom fiducial point, and determines a size based on the number of pixels between the top and bottom fiducial points.

The display may include one or more crosshairs for aiming the AI device at a desired target.

In one embodiment, the AI device further comprises wireless communication to communicate wirelessly with remote sensors, such as wind meters (also known as anemometers) or other atmospheric meters, or with a handheld rangefinder, smart scope, smart binocular, or other device.

The deep learning model comprises a deep neural network.

In some embodiments, the deep neural network is a convolutional neural network.

In some embodiments, a cropped image or a cropped aligned image is an input to the deep learning model.

During training, inputs to the deep learning model comprise a cropped image of the object and data regarding the object such as type of object, distance to object, size of the object between two fiducial points, gender, maturity, species, ethnicity, or geographic region.

During operation, the AI device recognizes the type of object, a top fiducial point and a bottom fiducial point based on the object type, and calculates a preliminary distance based on a known size of the type of object and the known magnification of the digital image.

In some embodiments, during operation the deep learning model further classifies the target object in classes, such as species, gender, maturity, vehicle type, vehicle make and model, vehicle year, and computes a more accurate final distance to the target based on the one or more classifications.

Natural object types may include deer, antelope, elk, wild boar, turkey, ground hog or other common game animals. Species classification may include, for example, mule deer, whitetail deer, blacktail deer, etc.

Man-made object types may include sedan, pickup truck, box truck, semi-truck (e.g., 18-wheeler), airplane, drone, tank. Vehicle classification may include make and model such as Toyota Tacoma, Ford F-450, Uralvagonzavod T-72, General Dynamics M1 Abrams tank, British Challenger 1 tank, BAE Systems Challenger 2 tank, HESA Shahed 136 drone, or ZALA Lancet-3 drone.

A method embodiment of using the AI device comprises the steps of:
a) training the deep learning model with a multiplicity of images of different types of objects and their distances,
b) aiming the AI device at the target by placing the crosshairs over the target,
c) pressing an operating button on the AI device, and
d) displaying a preliminary distance on the display.

In some method embodiments, the deep learning model classifies the target object and displays a more accurate final distance to the target based on the more precise classification. The classification, such a species or vehicle type or model, may also be displayed for user confirmation or education.

In some laser-less, no emission range finding device embodiments, the AI device comprises crosshairs for precisely aiming the device at a target and a means for sensing the angle to the target, such as an inclinometer, gyroscope, or accelerometer, wherein the AI device calculates a shoot for distance which is the estimated range to the object adjusted for shooting angle.

In some laser-less, no emission range finding device embodiments, the AI device is a handheld laser-less rangefinder.

In some laser-less, no emission range finding device embodiments, the AI device is a weapon mounted laser-less rifle scope.

In some laser-less, no emission range finding device embodiments, the AI device is a handheld laser-less binocular.

In some laser-less, no emission range finding device embodiments, the AI device is a handheld smart phone, such as an iPhone or Android phone.

In some laser-less, no emission range finding device embodiments, the AI determines a dynamic aiming point based on current wind and final distance and displays the aiming point when the wind is stable.

In some embodiments, a first image sensor is configured with a low magnification lens providing a low magnification digital image and a second image sensor is configured with a high magnification lens providing a high magnification digital image, and the display is configured to show both the low magnification digital image and the high magnification digital image.

In an embodiment with a high-resolution digital display, the low magnification digital image is displayed with crosshairs and is used to aim the AI device, and the high magnification digital image is used by the deep learning model to determine the final distance to the target.

In other embodiments, the AI device detects a plurality of objects and determines a final range to two or more of the objects.

In laser-less, no emission handheld rangefinder embodiments, objects of known size are detected and the distance or range to each object is determined by measuring the object's height in pixels, and calculating the line-of-sight distance to the object, using a known magnification factor of the lens. In some embodiments, the AI device comprises a tilt sensing means, such as a gyroscope or inclinometer. For example, the TDK InvenSense 9-Axis MEMS Motion Sensors combine a 3 axis gyroscope, 3 axis accelerometer, and 3 axis compass in the same chip together with an onboard Digital Motion Processor (DMP) capable of processing the complex MotionFusion algorithms. The source code for interfacing with any combination of gyroscope, accelerometer, or compass is available as open source. For example, Android Sensors are virtual devices that provide data coming from a set of physical sensors: accelerometers, gyroscopes, magnetometers, barometer, humidity, pressure, light, proximity and heart rate sensors. See the Android Open Source Project https://cs.android.com/android/platform/superproject.

A method embodiment of fast distance detection comprises steps of capturing a first image, determining the object type of the target in the first image, and then loading a fast detector based on the determined object type, and using only the fast detector to provide distance calculations in subsequent images of the target.

A method embodiment of determining an object type comprises steps of loading a variety of detectors which may using deep neural networks or algorithm models, wherein the detectors are trained to detect specific object types, scoring each of the variety of detectors on the same image, and using the score to determine the object type.

Other aspects and advantages of the present invention will be apparent from the following detailed description of the preferred embodiments and the accompanying drawing figures.

### Objects and Advantages

Accordingly, the present invention provides the following objects and advantages:

To provide a display that provides dynamic information regarding a projectile trajectory.

To provide a lightweight rangefinder comprising a high-resolution display and a digital camera, wherein the display provides an aiming point adjusted for wind and distance.

To provide lightweight, handheld AI device for recognizing distance to a desired target without emitting a laser beam or other radiation.

To provide an AI device, having a deep learning model, which is trained to recognize objects of known size and use the object size to determine distance.

To provide a laser-less, no emission handheld or portable range finding device.

### BRIEF DESCRIPTION OF DRAWINGS

A preferred embodiment of the present invention is described in detail below with reference to the attached drawing figures, wherein:

FIG. 1A illustrates an archer with a bow with a bow sight;

FIG. 1B illustrates a rifle with a scope;

FIG. 2 illustrates a smart monocular with a digital camera image sensor;

FIG. 3 is a block diagram of an AI device;

FIG. 4 illustrates the AI device in a housing and an operating button input;

FIG. 5 illustrates the training of the AI device with a string, supported by a near rod and a far rod, and wind sensors, positioned along a projectile trajectory path to a target;

FIG. 6A illustrates an archer with a bow and the projectile trajectory path of an arrow to a target;

FIG. 6B illustrates a user with a rifle and the projectile trajectory path of a bullet to a target;

FIGS. 7A through 7C illustrate a plurality of strings, each positioned at different segments and heights along a projectile trajectory path to a target;

FIGS. 8A through 8D illustrate a flexible rod and extensions, preferable marked with dark and light bands;

FIGS. 9A and 9B illustrate lockable inserting ends and receiving ends for embodiments of the flexible rod and extensions, and FIG. 9B further illustrates a ground stake for supporting the rod assembly;

FIGS. 10A through 10F illustrate the use and operation of the AI device:

FIG. 10A illustrates the AI device with a string and rods, positioned along a projectile trajectory path to a target,

FIG. 10B illustrates an image captured by the AI device showing string shape and position, visually relative height of the flexible rods supporting the string, and the flex of the rods,

FIG. 10C illustrates a detection crop of the image with four bounding points forming a bounding rectangle containing the cropped image of the string and rods,

FIG. 10D illustrates fiducial points found on the string and rods,

FIG. 10E illustrates fiducial points defining the shape and position of the string,

FIG. 10F illustrates fiducial points defining the flex of the flexible rod;

FIGS. 11A and 11B illustrates a plurality of strings, each positioned at different angles relative to the projectile trajectory path to the target;

FIG. 12 illustrates a display with indication of the crosswind speed relative to the path to the desired target, and indicators of a predicted steady state of optimum wind;

FIG. 13 illustrates crosswind and tailwind vector elements of wind;

FIGS. 14A and 14B illustrate embodiments of display elements with crosswind speed and direction indicators and with headwind/tailwind speed indicator. FIG. 14B includes indicators of a steady state of optimum wind;

FIGS. 15A through 15C illustrate a display with indication of the crosswind speed and direction and headwind/tailwind speed, each relative to the path to the desired target, indicators of a steady state of optimum wind, and an adjusted aiming point, the aiming point adjusted for crosswind and range adjusted for tailwind/headwind;

FIG. 16 shows a high-resolution digital display, such as on an iPhone, providing indication of the crosswind speed and direction and headwind/tailwind speed, indicators of a steady state of optimum wind, and an adjusted aiming point, the aiming point adjusted for crosswind and range adjusted for tailwind/headwind;

FIG. 17 is a rear perspective view of a digital rangefinder device;

FIG. 18 is a front perspective view of the rangefinder device of FIG. 17;

FIG. 19 illustrates a string and flexible rods placed in a harsh, rough environment with hills and valleys and strong winds at different speeds and directions along the projectile trajectory path;

FIG. 20 is a block diagram of a laser-less, no emission range finding device;

FIG. 21A illustrates a string and flexible rods showing the visually relative height of the rods;

FIG. 21B show a high magnification of the target in FIG. 21A;

FIGS. 22A through 22G illustrate detection of objects with known sizes;

FIGS. 23A through 23G show fiducial points for each detected object;

FIGS. 24A and 24B show displays for laser-less, no emission, range finding devices;

FIG. 25 is a rear perspective view of a smartphone-based rangefinder AI device;

FIG. 26 is a front perspective view of smartphone-based rangefinder AI device of FIG. 25;

FIG. 27A through 27C illustrate a high-resolution digital display embodiment showing low magnification digital images side-by-side with high magnification digital images with crosshairs and aiming points;

FIG. 28 illustrates a method of determining object type with a slower detector and then loading a fast detector based on the determined object type to process and identify ranges in subsequent images that contain the determined object type;

FIG. 29 illustrates details of an embodiment of a method of determining object type by load a plurality of detectors and scoring the results of each detector;

FIG. 30 illustrates an AI device with a high-resolution digital display viewed through an eyepiece;

FIG. 31 illustrates an exemplary deep neural network;

FIG. 32 illustrates a deer with six fiduciary points;

FIG. 33 illustrates a buck and doe on a mountain side each with six fiduciary points;

FIG. 34 illustrates a deer with 20 fiduciary points; and

FIG. 35A and FIG. 35B a tank with 22 fiduciary points before and after 2D alignment.

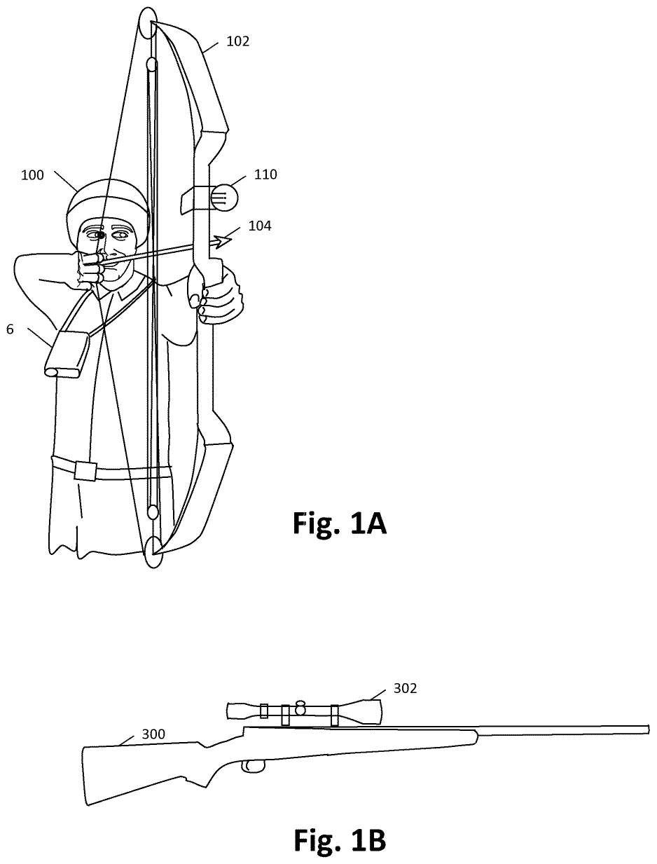

The drawing figures do not limit the present invention to the specific embodiments disclosed and described herein. The drawings are not necessarily to scale, emphasis instead being placed upon clearly illustrating the principles of the invention.

REFERENCE NUMERALS IN DRAWINGS

| | | |
|---|---|---|
| 2 | | projectile trajectory |
| 3 | | line of sight |
| 6 | | rangefinder |
| 10 | | AI device |
| 11 | | iPhone |
| 13 | | range sensing means |
| 15 | | 9-axis sensor |
| 16 | | computing element |
| 18 | | memory |
| 19 | | wireless communications |
| 20 | | housing |
| 21 | | alternate housing |
| 22 | | eyepiece |
| 24 | a-b | lens |
| 25 | a-c | image sensor (digital camera) |
| 26 | | distal end |
| 28 | | proximate end |
| 29 | | audio sensor |
| 30 | | display |
| 31 | | high-resolution display |
| 32 | a-b | inputs |
| 35 | | visor or shroud |
| 36 | a-b | image |
| 37 | a-d | bounding point |
| 38 | a-v | fiducial point |
| 39 | | battery compartment |
| 40 | a-c | string |
| 48 | a-c | wind |
| 52 | | crosswind vector |
| 56 | | tailwind vector |
| 82 | | yes path |
| 86 | | no path |
| 90 | | deer |
| 91 | | antelope |
| 92 | | elk |
| 93 | | turkey |
| 94 | | ground hog |
| 95 | | man |
| 96 | | tank |
| 100 | | archer or user |
| 102 | | bow |
| 104 | | arrow |
| 106 | a-f | flexible rod |
| 110 | | bow sight |
| 199 | a-c | extension |
| 280 | | fast detection method |
| 282 | | capture image |
| 284 | | determine object type |
| 286 | | load fast detector |
| 288 | | process next image |
| 289 | | found |
| 290 | | determine object type method |
| 292 | | load DNN detectors |
| 294 | | load SVM detectors |
| 296 | | score each detector |
| 298 | | select object type based on score |
| 300 | | rifle |
| 302 | | scope |
| 310 | | high-resolution AI device |
| 410 | | monocular |
| 680 | a-c | wind sensor |
| 802 | a-c | dark band |
| 804 | a-b | light band |
| 900 | a-b | crosshairs |
| 902 | | magnification outline |
| 914 | a-d | horizontal distance indicator |
| 922 | | crosswind indicator |
| 924 | | green indicator |
| 926 | | yellow indicator |
| 928 | | red indicator |
| 982 | a-b | aiming point |
| 1054 | | deer reference image |
| 1070 | | inserting end (male) |
| 1072 | | receiving end (female) |
| 1097 | | protrusion indicator |
| 2235 | | horizontal leg |
| 3094 | | locking channel |
| 3104 | | sleeve |
| 3196 | | outward protrusion |
| 3450 | | stake |
| 3454 | | stake member |
| C1 | | convolutional layer 1 |
| C2 | | convolutional layer 2 |
| C3 | | convolutional layer 3 |
| C4 | | convolutional layer 4 |
| C5 | | convolutional layer 5 |
| C6 | | convolutional layer 6 |
| C7 | | convolutional layer 7 |
| P | 0, 20, 100 | point |
| T | | target |
| V | | vertex |

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### The String

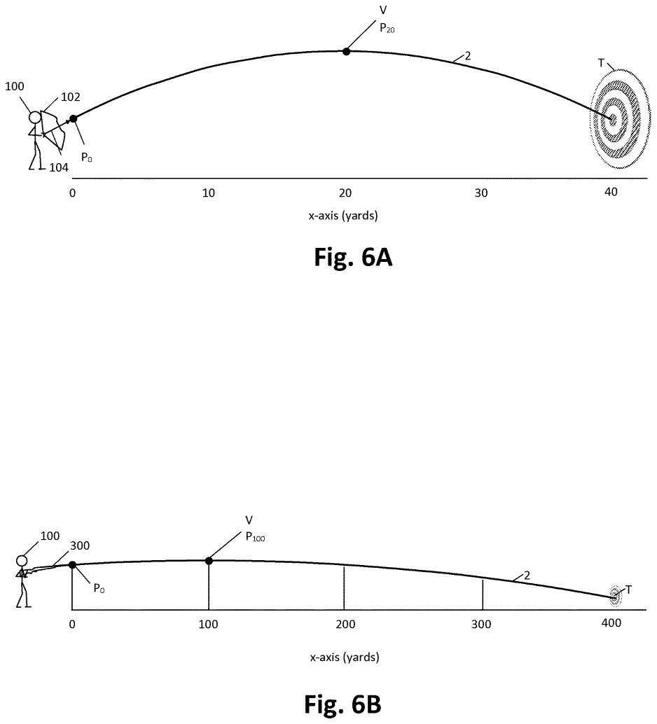

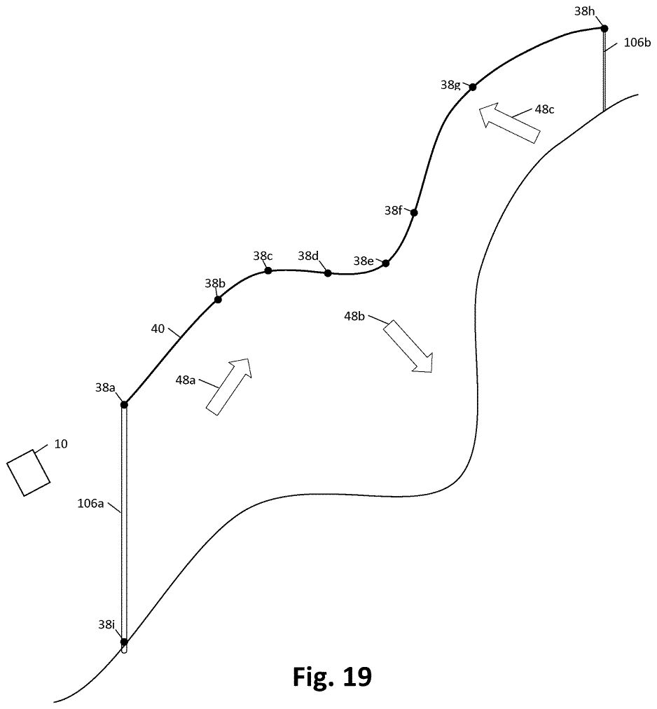

Over a decade ago we performed an experiment with a 270-yard string 40 supported by two flexible rods 106 in a harsh, rough environment with hills and valleys and strong winds at different speeds and directions (see FIG. 19) along the projectile trajectory path 2 to a target T (see FIG. 6B). We discovered that the “string is the teacher.” By observing the effects of the combined winds on the string, including both the sounds and the visual image of the string and the flexible rods, a human users could determine a period of consistent wind, adjust their aim for that wind, and repeatedly hit the target using that aim each time the users sensed the presence of the optimum steady wind conditions. The sound of the wind was easier to distinguish at higher wind speeds. In our experiment, the string taught us how to adjust our aim and when we could repeat a shot under the same and highly similar instantaneous wind conditions. The bullets consistently hit a desired target at 270 yards in strong dynamic wind conditions.

In our experiment, we used a 600-yard spool of 80-pound test Izorline braided low stretch Dacron fishing line, UPC 8783700307. The string was white with “greenspot” spiral markings.

We discovered that the string is the teacher. What was needed were low cost, light weight, portable platforms with high quality optics, digital camera, and computing capabilities so that we could implement a machine learning solution which could also be taught by the string and could instantaneously observe current wind effects and provide crosswind and headwind/tailwind information; could determine a presence of a stable optimum wind, and display an adjusted aiming point. With advances in AI technology and platforms that can be made available to general users, we can now implement our invention as devices and methods for recognizing wind along a projectile trajectory path so that a user can accurately aim and hit a desired target regardless of the wind speed and direction at different points along the path, and provide an indication that wind currently is in a likely sustained favorable state for a brief period of time, such that a user has time to aim and fire.

More recently, we have experimented with supporting the string with flexible rods with equal height, e.g., 5-foot rods, preferably with 6-inch bands of darker color and/or reflective materials. We have experimented with different strings and have had good results with green mono filament line. To aid in recognizing the wind, by observing the string, it is useful to know the amount of string. An AI device can recognize the distance of an object of a known size, such as the flexible rod, animal, bird, or vehicle, by analyzing its visually apparent size in the image at a known magnification.

Accordingly, we disclose the following AI devices and methods in a handheld or portable hand-carried device to observe objects, such string support rods, birds, mammals, such as deer or elk, or vehicles, such as trucks or tanks, each object type having a known size, and to recognize the distance to each object. The AI is embedded in an AI device having an image sensor and optional laser rangefinder for training the AI. The present invention also relates to devices such as smart rifle scope, handheld rangefinders, smart binoculars, smart phones, and smart tablets which comprise a trained AI, the device is used to select a target, determine the predicted distance to the target, and display a distance adjusted aiming point.

### AI Device

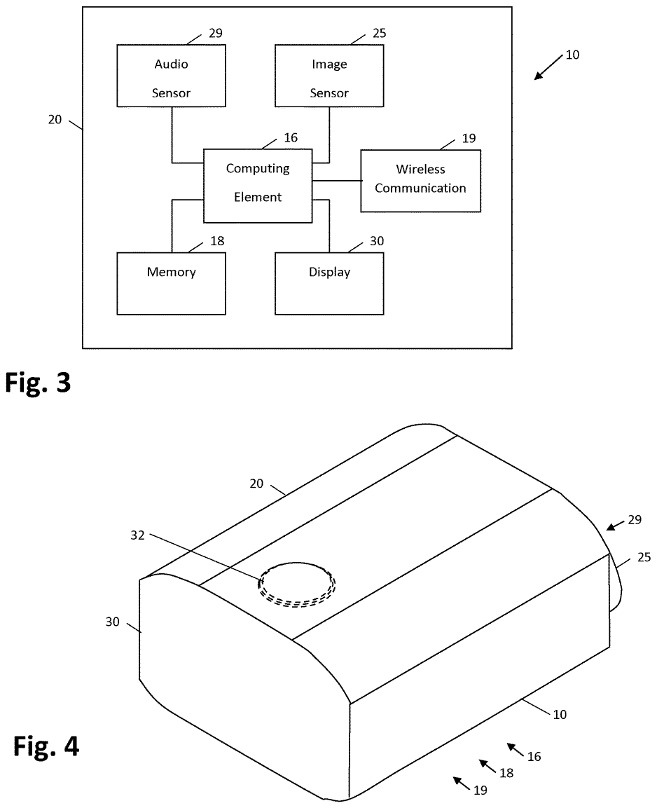

FIG. 3 illustrates our novel AI device 10 comprising a computing element 16, coupled with memory 18, an audio sensor 29 or an image sensor 25, a display 30, and wireless communications 19. A housing 20 contains the elements of the device 10.

FIG. 4 shows our novel AI device 10 comprising a housing 20 supporting a display 30, an operating button input 32. The components inside the housing 20 comprise: computing element 16, memory 18, wireless communications 19, image sensor (digital camera) 25, audio sensor 29. One or both, of the image sensor 25 and the audio sensor 29, is configured in different embodiments.

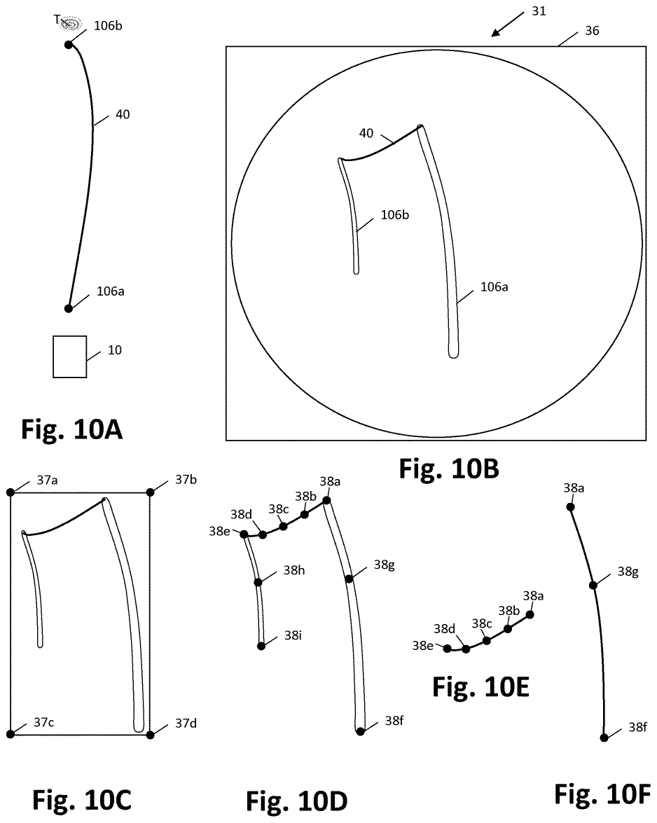

The display 30 could be a high-resolution, touch screen display 31 (see FIGS. 10B, 15A through 15C, 16, 17, 18, 24A and 24B).

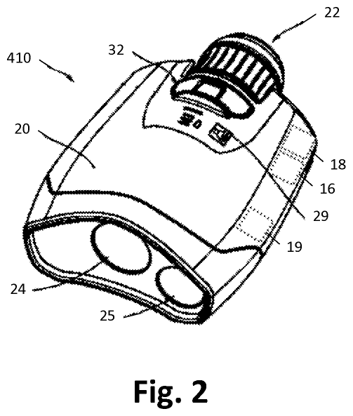

Comparing FIG. 4 to FIG. 2 results in understanding that while Swarovski binocular is an enabling platform for our present invention, it contains elements which are not required by our present invention. In other words, the reader should understand that the present invention could be implemented entirely on a Swarovski binocular or similar device but could also be implemented as disclosed herein without requiring the invention claimed by Swarovski. Further, Swarovski only clearly discloses identification of birds and mountain peaks. It is silent on determining range, on recognizing wind, or on projectile trajectory paths.

The handheld housing 20 enables AI device 10 to be easily and safely transported and maneuvered for convenient use in a variety of locations.

For example, the portable handheld housing 20 may be easily transported in a backpack for use in the field. Additionally, the location of the components on or within the housing 20 and the location of the button 32, enables AI device 10 to be easily and quickly operated by the user with one hand without a great expenditure of time or effort.

A computer program preferably controls input and operation of the AI device 10. The computer program includes at least one code segment stored in or on a computer-readable medium residing on or accessible by AI device 10 for instructing computing element 16, image sensor 25, audio sensor 29, and any other related components to operate in the manner described herein. The computer program is preferably stored within the memory 18 and comprises an ordered listing of executable instructions for implementing logical functions in AI device 10. However, the computer program may comprise programs and methods for implementing functions in the device 10 which are not an ordered listing, such as hard-wired electronic components, programmable logic such as field-programmable gate arrays (FPGAs), application specific integrated circuits, conventional methods for controlling the operation of electrical or other computing devices, etc.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

AI device 10 and computer programs described herein are merely examples of a device and programs that may be used to implement the present invention and may be replaced with other devices and programs without departing from the scope of the present invention.

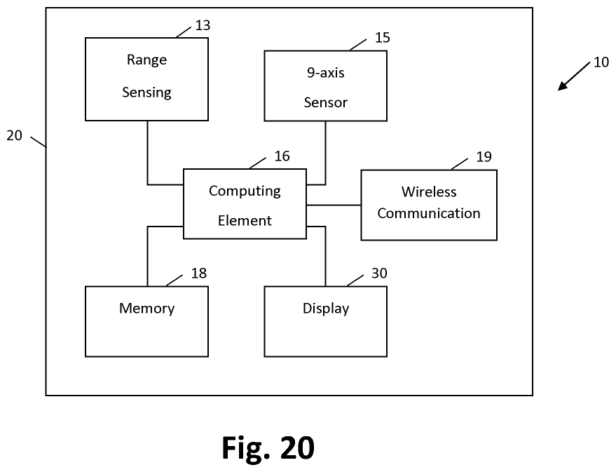

The computing element 16 is coupled with image sensor 25, audio sensor 29, wireless communication 19, 9-axis sensor 15 (FIG. 20) to determine ballistic information relating to the target T, including wind effect information, range, and shooting angle, as is discussed herein. The computing element 16 may be a microprocessor, microcontroller, or other electrical element or combination of elements, such as a single integrated circuit housed in a single package, multiple integrated circuits housed in single or multiple packages, or any other combination. Similarly, the computing element 16 may be any element that is operable to determine clear shot information from the range and angle information as well as other information as described herein. Thus, the computing element 16 is not limited to conventional microprocessor or microcontroller elements and may include any element that is operable to perform the functions described.

The memory 18 is coupled with the computing element 16 and is operable to store the computer program and a database including trained representation and classification for comparison, and configuration information. The memory 18 may be, for example, an electronic, magnetic, optical, electromagnetic, infrared, or semi-conductor system, apparatus, device, or propagation medium.

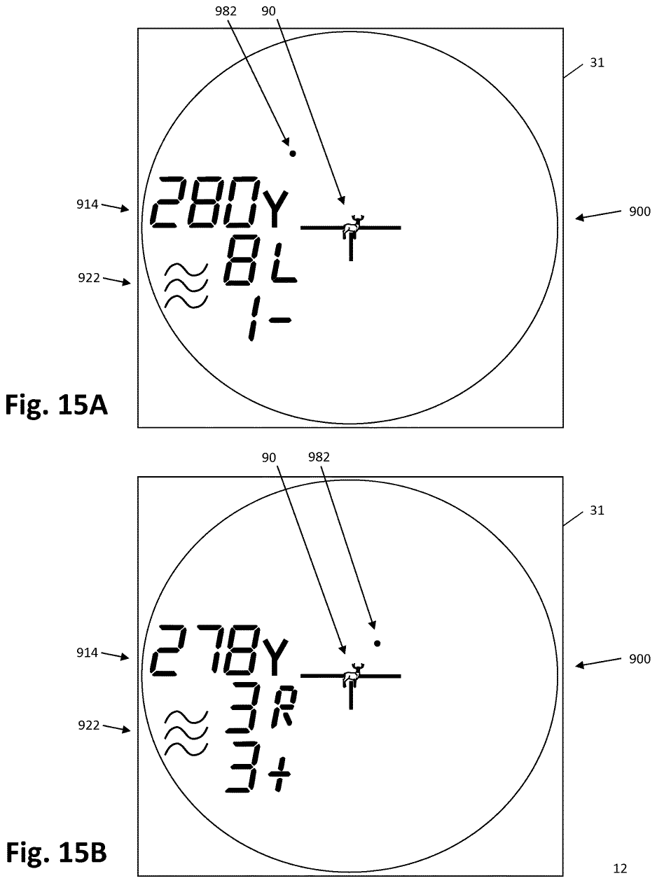

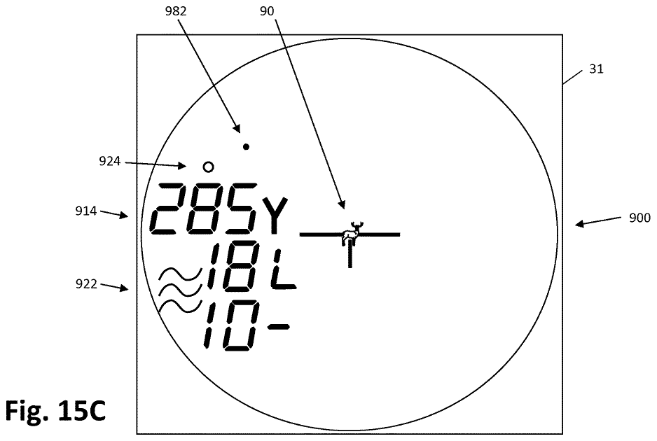

The device 10 also preferably includes a display 30 to indicate relevant information such as the crosshairs 900, horizontal distance indicator 914, and other indicators disclosed herein (e.g. FIG. 15A). The display 30 may be a conventional electronic display, such as an OLED, TLED LED, TFT, or LCD display, or a higher resolution pixel matrix, e.g., with a resolution of 304×256.

The inputs 32 are coupled with the computing element 16 to enable users or other devices to share information with AI device 10. The inputs 32 are preferably positioned on the housing 20 to enable the user to simultaneously view the display 30 and function the inputs 32.

The inputs 32 preferably comprise one or more functionable inputs such as buttons, switches, scroll wheels, etc., a touch screen associated with the display 30, voice recognition elements, pointing devices such as mice, touchpads, trackballs, styluses, combinations thereof, etc. Further, the inputs 32 may comprise wired or wireless data transfer elements.

### Training

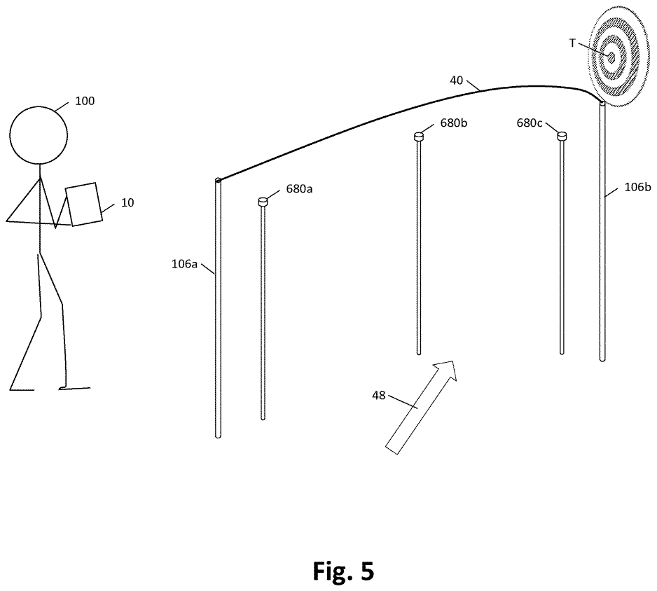

FIG. 5 illustrates the training of the AI device 10 with a string 40 and wind sensors 680a through 680c, positioned along a projectile trajectory path to a target T.

The user 100 is shown with the AI device 10. The string 40 is supported two flexible rods 106, namely near rod 106a and a far rod 106b. The rods 106 hold the string 40 off the ground in the wind 48 along at least a segment of the projectile trajectory path 2 (shown, for example, in FIG. 6A and FIG. 6B). In other embodiments for wind detection, the string could be attached to two fixed points one at each end.

The string 40 shows that the wind 48 has both a tailwind and left moving cross wind (see FIG. 13). The tailwind is evidenced by the curve of the string 40 toward the target T, at the far rod 106b. The left moving crosswind is evidenced by the curve of the string 40 toward the left of the line of sight to the target, and to the left of the two rods 106.

The AI device 10 is positioned where it can sense the string 40 and the rods 106. In some embodiments, the AI device 10 senses the sound made by the wind 48 as it moves and passes over the string 40. In some embodiments, the AI device 10 senses the image made by the wind 48 as it dynamically moves the string 40 and flexes the rods 106. In other embodiments it senses both sound, with the audio sensor 29 (FIG. 3 and FIG. 4), and photos or videos, with the image sensor 25 (FIG. 3 and FIG. 4).

A plurality of conventional wind meters 680 (also known as anemometers) are shown positioned along path of the string 40.

Wind meters are well known in the art, such as Kestrel 1000 wind meter or the Kestrel 3550FW fire weather meter. Wind meters are known to provide wind direction and speed via wireless communications.

The grandparent application introduces a new class of anemometer, namely, a string anemometer which senses the wind along the full path to a target, not just a few finite points along the path.

Our U.S. Pat. No. 8,795,109, issued Aug. 5, 2014, and U.S. Pat. No. 9,482,505, issued Nov. 1, 2016, both included by reference, disclose and claim a wind tracking apparatus which can be deployed by shooting an arrow comprising a wind meter or wind sensor 680 on nock end of the arrow, which then wirelessly transmits wind speed and direction. One wind meter or sensor was disclosed as an ultrasonic anemometer.

A large multiplicity of images 36 (FIG. 10B) and/or audio are captured by an embodiment of the AI device 10, such as monocular AI device 410 of FIG. 2, or other conventional recording means such as cameras, audio records, or smart phones 11, such as iPhones. The multiplicity of images 36 (FIG. 10B) and/or audio are capture while observing the string 40 during thousands of different wind conditions. With each image or audio capture, the wind information from the plurality of wind meters 680 are received wirelessly and stored in a dataset along with each image or audio recording. The dataset is used as input to train the deep learning model of the AI device 10.

### Projectile Trajectory Paths

FIG. 6A illustrates an archer 100 with a bow 102 and the projectile trajectory path 2 of an arrow 104 to a target T. As discussed above the path is generally parabolic but is affected by many factors for the true ballistic path.

As shown in FIG. 6A the arrow starts at point P₀ and at 20 yards pass through point P₂₀, which is the vertex V of the projectile trajectory path 2, when aimed at a 40-yard target T.

FIG. 6B illustrates a user 100 with a rifle 300 and the projectile trajectory path 2 of a bullet to a target T.

As shown in FIG. 6B the bullet starts at point about 5 feet above the ground and then climbs to a vertex V at 100 yards, passing through point P₁₀₀, when the rifle 300 is aimed at a 400-yard target T. The vertex V about 5½ feet above the ground (e.g., 6-inch rise). The path is about 5 feet at 200 yards and 3½ feet at 300 yards. The path drops off quickly to the target during the last 100 yards as the bullet velocity drops due to wind drag.

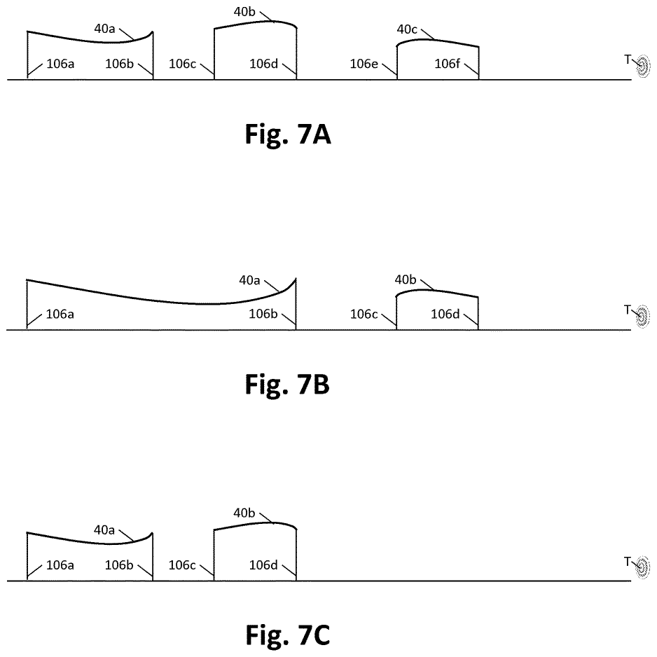

As seen in both FIG. 6A and FIG. 6B, the projectile trajectory path 2 is higher than the height at P₀. Accordingly, the wind may be different at different height, and it would be preferred to recognize the wind 48 at different heights (see e.g. FIG. 5 above and FIGS. 7A through 7C below).

### Multiple String Segments at Different Heights

FIGS. 7A through 7C illustrates a plurality of strings 40, each positioned at different segments and heights along a projectile trajectory path 2 (shown in FIG. 6A and FIG. 6B) to a target T. As shown in each figure, the wind's effect on the string 40 may be different in each segment.

FIG. 7A shows three strings 40a through 40c, respectively, supported by pairs of rods 106, 106a-b, 106c-d, and 106e-f, respectively. String 40b is supported at a higher position than string 40a. String 40c is supported at a lower position than string 40a. These heights correspond to the projectile trajectory path 2 for a rifle (shown in FIG. 6B). For example, string 40a is supported at 5 feet, string 40b is supported at 5½ feet, and string 40c is supported at 3½ feet. At these different heights the AI device 10 can better recognize the wind effect on the bullet, e.g., along projectile trajectory path 2 for a rifle (shown in FIG. 6B).

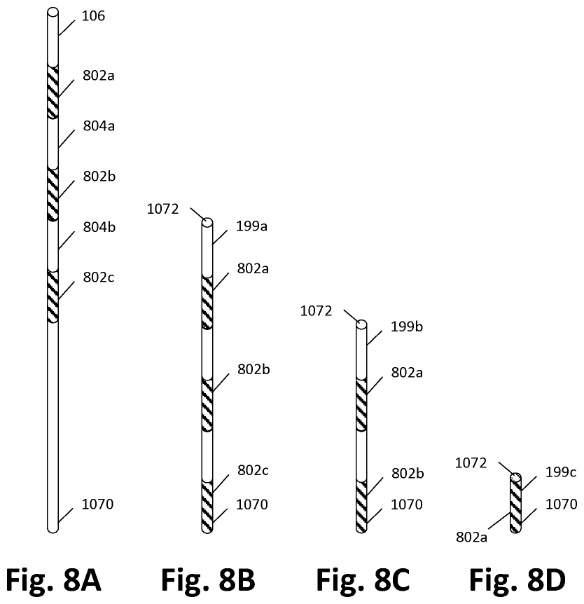

With preferred embodiments using banded rods, the AI device is better able to detect the rods and their height. For example, in this example, 5 feet (see FIG. 8A), 5½ feet (FIG. 8A combined with FIG. 8D), and 3½ feet (FIG. 8B combined with FIG. 8D), respectively.

FIG. 7B shows two strings 40a and 40b, respectively, supported by pairs of rods 106, 106a-b and 106c-d, respectively. String 40a is supported at a higher position along a relative longer segment.

FIG. 7C shows two strings 40a and 40b, respectively, supported by pairs of rods 106, 106a-b and 106c-d, respectively. String 40b is supported at a higher position near the vertex. String 40a would help detect the initial wind impact on the path. String 40b would detect the wind impact at the higher part of the path.

### Flexible Rods and Extensions

As shown in the previous figures, it is advantageous to have rods 106 of different lengths. FIGS. 8A through 8D illustrates a flexible rod 106 and extensions 199b, preferable marked with dark bands 802 and light bands 804.

FIG. 8A illustrates a flexible rod 106, preferable marked with dark bands 802 and light bands 804. Dark bands 802a, 802b, and 802c are preferably 6-inches long and are separated by 6-inch long light bands 804a and 804b. In this preferred embodiment the rod is 5 feet long, and the 3 feet are easily identified at the bottom of each dark band 802, namely, 1 foot at the bottom of 802a, 2 feet at the bottom of 802b, and 3 feet at the bottom of 802c. The bottom of the rod 106 is an inserting end 1070.

The dark bands 802 and light bands 804 of a predetermined length aid the AI device is detecting the location and flex of the rod 106. Further, the AI device determines the distance from the AI device to each rod 106 and determines length of the string based on the distance between the near rod 106a and the far rod 106b (FIG. 5). While not required, the dark bands 802 and light bands 804 enhance the captured images 36 (FIG. 10B) and improve the rod 106 and string 40 recognition, detection, and alignment.

FIG. 8B illustrates a 3-foot rod extension 199a, preferable marked with dark bands 802 and light bands 804.

FIG. 8C illustrates a 2-foot rod extension 199b, preferable marked with dark bands 802 and light bands 804.

FIG. 8D illustrates a 6-inch rod extension 199c, preferable marked with a dark band 802.

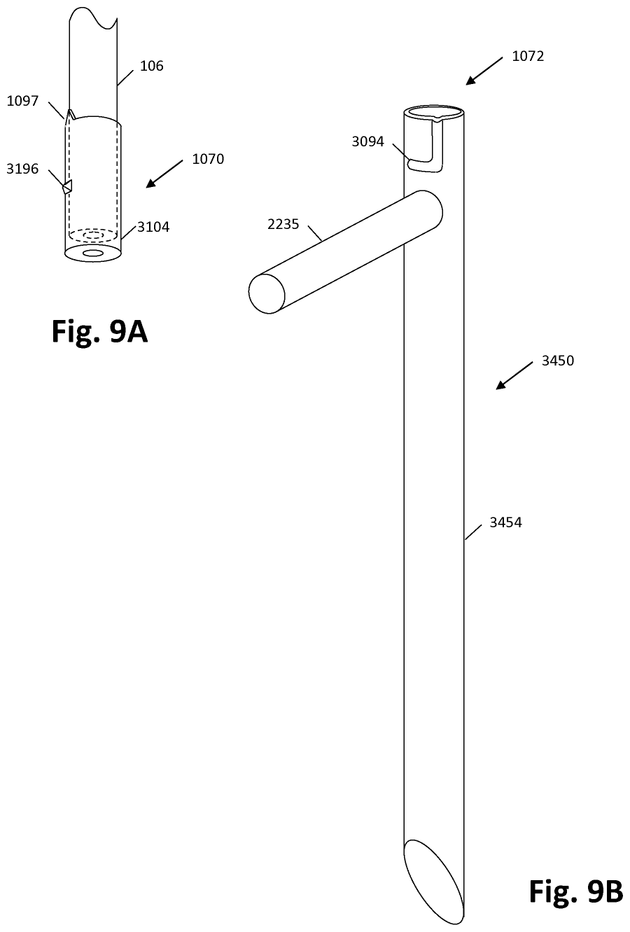

The bottom of each rod extension 199 is an inserting end 1070. The top of extensions 199a-c are receiving ends 1072 (see FIG. 9B), each configured to receive an inserting end 1070.

The different rod 106 and rod extension 199a through 199c sizes provide for configuration of support rods 106 of different lengths. However, the rod 106 can be broken down and carried in a smaller bag. A 5-foot rod 106 is configured from a 3-foot extension 199a and 2-foot extension 199b. All three extensions 199a-c could be configured for the 5½ foot support needed to place a wind sensor 680 at P₁₀₀ in FIG. 6B.

FIGS. 9A and 9B illustrates lockable inserting ends 1070 and receiving ends 1072 for embodiments of the flexible rod and extensions. FIG. 9B further illustrates a ground stake 3450 for supporting any rod assembly (comprising rod 106 and extensions 199).

Our U.S. Pat. Nos. 7,841,355 and 8,789,550 disclose sleeve 3104 having an outward protrusion 3196 and protrusion indicator 1097, shown on the inserting end 1070 in FIG. 9A, and a locking channel 3094 on the receiving end 1072 and a ground stake 3450 as shown in FIG. 9B.

The ground stake 3450, in addition to the locking receiving end 1072, comprises a pointed stake member 3454 for insertion into the ground, and a horizonal leg 2235 which aids ground insertion and removal. For example, a user steps on the horizontal leg when placing the rod 106 in the ground.

Each of the inserting ends 1070 rod 106 and rod extension 199a through 199c can be inserted and locked into any of the receiving ends 1072 of rod extensions 199 and the ground stake 3450, to configure a flexible rod 106 which can be removably placed in the ground.

### Deep Learning Model Use and Operation

FIGS. 10A through 10F illustrates the use and operation of the AI device 10.

FIG. 10A illustrates positioning the AI device 10, flexible rods 106a and 106b, and the string 40 along a projectile trajectory path to a target T. The AI device should be positioned about six feet from the near rod 106a with a full view of the string 400 and both rods 106a and 106b. This is the positioning step.

FIG. 10B illustrates an image 36 captured by the AI device 10. The image is displayed on a high-resolution display 31, showing the shape and position of the string 40. The image 36 also shows the flex and relative positions of the flexible rods 106a and 106b, which also mark the ends of the string 40. This is the capture step.

FIG. 10C illustrates a detection crop from the image 36 with four bounding points 37a-d forming a bounding rectangle containing the cropped image of the string 40 and rods 106, which is cropped from the image 36 of FIG. 10B. This is the first part of the detection step.

FIG. 10D illustrates fiducial points 38 found on the string and rods of the cropped image of FIG. 10C. Fiducial points 38a through 38e mark the curve of the string in the cropped image. Fiducial points 38a and 38f mark the ends of the near rod in the cropped image. Fiducial points 38e and 38i mark the ends of the far rod in the cropped image. Fiducial points 38a, 38g, and 38f mark the curve of the near rod. Fiducial points 38e, 38h, and 38i mark the curve of the far rod. Determining the fiducial points 38 is the second part of the detection step. The tar weight of the string plus the collective force of the wind against the string pull the rods toward each other, such that the direction of the flex of the rod is parallel with the string. A pulley near the near rod allows the direction flex of the rod 106a to be rotated, e.g., 90 degrees, such that the same camera captures the shape of the string 40 and the flex of the near rod 106 in the same image (not shown).

Knowing the focal magnification of the image, and preferably using the dark band 802 and light bands 804 visualized in the captured image, the computing element 16 (FIG. 3 and FIG. 4) can determine the distance of the near rod 106a from the image sensor 25, the distance from the near rod 106a to the far rod 106b which is the same as the length of the string 40, and the length of the rods 106. Later, the alignment step uses these length and distances to scale the cropped image.

The distance of the near rod 106a from the image sensor 25 optionally is an input to the deep learning model.

In another embodiment the AI device 10 measures the height of the portion of the near rod 106a (e.g., by using the bottom of the dark bands 802a, 802b, 802c) in pixels, and determines the distance from the camera to the near rod 106a.

The distance from the near rod 106a to the far rod 106b provides information regarding the tar weight of the string, which may be an input to the deep learning model, and an input to the trained model when determining the wind direction and speed.

FIG. 10E illustrates fiducial points 38 defining the shape and position of the string (in this case 38a through 38e).

FIG. 10F illustrates fiducial points 38 defining the flex of a flexible rod (in this case 38a, 38g, and 38f showing the curve of the near rod 106a.

Next in the alignment step, the cropped image scaled to a standard size. The length of the near rod is used as the standard for scaling. Thus, the user can place the AI device 10 at any reasonable distance from the near rod 106a. This removes the need for the user to measure the placement for accuracy of the deep learning model.

DeepFace teaches that near 100% face recognition can be achieved with both 2D rotation and 3D alignment. Alignment is optional. In our preferred embodiment, 3D alignment using the fiducial points 38, as well as determined lengths and distances, is used to align the top of both rods 106a and 106b in the center of the aligned image such that the flex of both rods and the entire string 40 curve(s) are visualized in the aligned image. This removes the need for the user to worry about the height or exact placement of the AI device 10 when capturing images.

These comprise the alignment step. The alignment is applied by transforming the fiducial points. After the fiducial points have been aligned, the image pixels are no longer needed,

The cropped, scaled, 2D aligned, and optionally 3D aligned fiducial points for each of a multiplicity of images 36, as well as the wind sensor information captured at the same time as the image, are given as inputs to the deep neural networks (DNN). Optionally, a concurrent sound recording is converted to a spectrogram and the spectrogram fiducial contours are given as an input to the DNN.

The DNN is trained on the wind recognition task with a goal of output a wind direction and speed in relation to the directional alignment of the bottom of each rod 106 (which represents the direction of the target T. In a currently preferred embodiment, there is no need to visualize or detect the target itself. This simplifies the parameters of the DNN.

In simple terms, the DNN is used to classify the multiplicity of images 36 to a particular crosswind class (and optionally headwind/tailwind class). Once trained the AI device 10 can classify a single new image and/or sound, and output a particular crosswind and tailwind based on a matching class. See operation below.

In practice, a very small percentage of shots need to be taken in winds greater than 30 m.p.h. (miles per hour). Thus, the ability to identify 60 distinct classes for cross wind (e.g., 30 from left cross winds from 0 to 30 m.p.h. and 30 for right cross winds from 0 to 30 m.p.h.) should be sufficient for general hunting or target shooting applications. Our model thus is less complex, smaller, and faster than the DeepFace model.

DeepFace also teaches that the number of layers in the DNN can be varied to simplify or to enhance the error rates. Accordingly, one skilled in the arts of computer vision and machine learning, and in particular DNN-based image classification would be able to modify the DNN to meet their particular needs and parameters of their product (such as process speed, memory size, battery life, etc.).

In one embodiment of the DNN, only the string fiducial points 38 are used. In another embodiment of the DNN only the rod fiducial points 38 are used. In yet another embodiment only the near rod fiducial points and the sound fiducial contours are used. To be clear, each input is labeled with sensed wind values from one or more wind sensors 860.

In yet other embodiments, the strings 40 and rods 106 are positioned at an angle such as a 90 degree angle from each other.

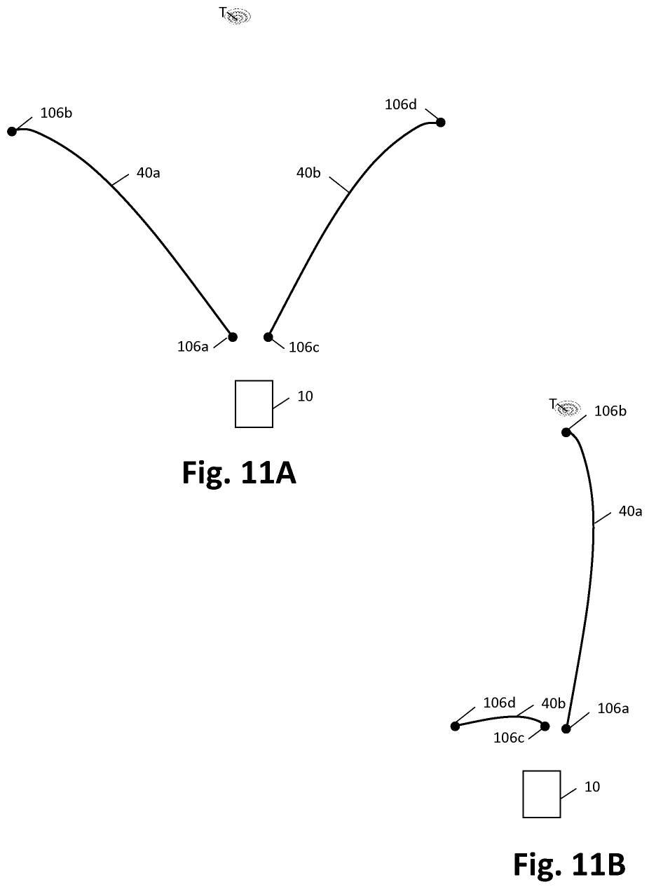

FIGS. 11A and 11B illustrate a plurality of strings 40, each positioned at different angles relative to the projectile trajectory path to the target T. Both FIG. 11A and FIG. 11B illustrate the placement of AI device 10.

FIG. 11A illustrates a left string 40a supported by rods 106a and 106b generally angled 45 degrees to the left of the target T, and a right string 40b supported by rods 106c and 106d generally angled 45 degrees to the right of the target T, such that the strings 40a and 40b generally form a 90 degree angle.

FIG. 11B illustrates a string 40a supported by rods 106a and 106b generally angled along the projectile trajectory path to the target T, and a tailwind string 40b supported by rods 106c and 106d generally angled 90 degrees generally on a line perpendicular to the target T, such that the strings 40a and 40b generally form a 90 degree angle. String 40b is much shorter than string 40a, as its role is to measure headwind and tailwind relative at the origin of the shot, and so it is more easily visualized in the field of view of the AI device 10. The embodiment shown in FIG. 11B is currently preferred over the model shown in FIG. 10A when headwind/tailwind output is desired from the DNN.

### Field Use and Operation of the Trained AI Device

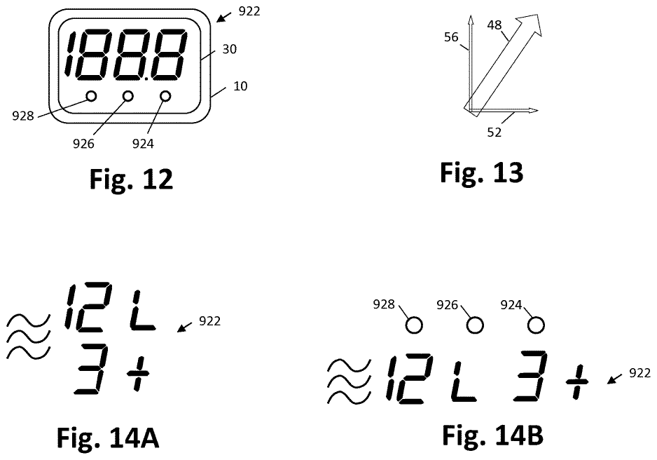

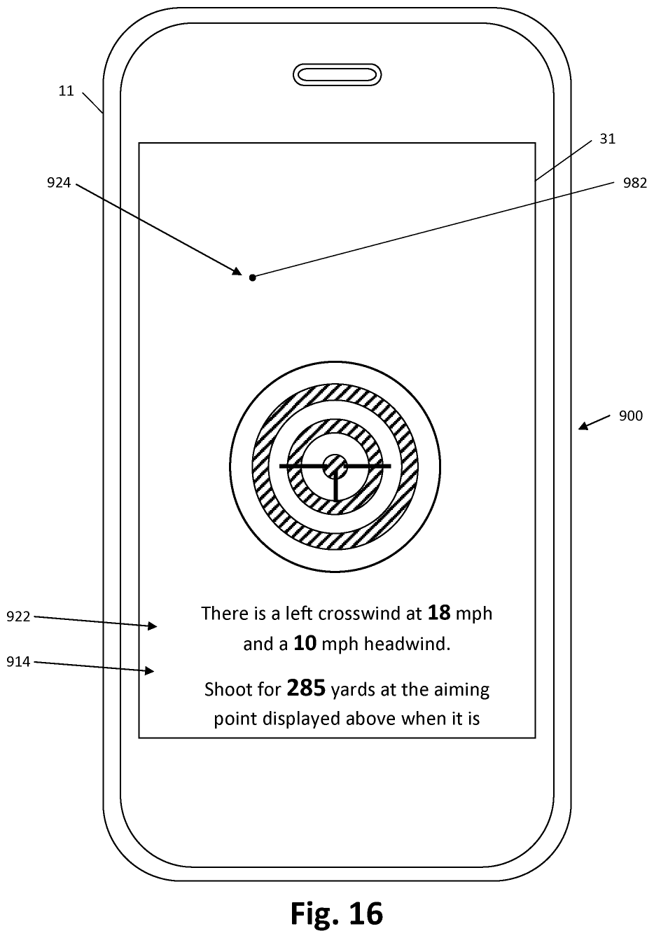

FIG. 12 shows an embodiment of display 30 as shown for example on the form factor of the AI device 10 shown in FIG. 4. This embodiment does not require a high-resolution display 31 (for example, as shown in FIG. 10B, FIGS. 15A through 15C, or FIG. 16). This embodiment of AI device 10 may be carried by hand or mounted in a fixed position, such as on a tripod at a shooting range or on a tree stand or in a hunting blind. Under one setting it operates automatically to periodically display crosswind information, in a crosswind indicator 922, and, optionally, display the state of a steady optimum wind condition by illuminating at green indicator 924. A yellow indicator 926 indicates that the optimum wind condition is approaching. The red indicator 928 indicates that the wind is too strong or unpredictable at the moment.

FIG. 13 illustrates crosswind and tailwind vector elements of wind 48, namely crosswind vector 52 is the crosswind element and tailwind vector 56 is the tailwind vector which is in the negative director for headwind.

FIGS. 14A through 14B illustrate embodiments of display 30 or high-resolution display 31 elements with crosswind speed indicators and with headwind/tailwind speed indicators as part of crosswind indicator 922. A wind icon is shown as three waves as a visual clue to the viewer. As shown the current crosswind has been recognized as 12 m.p.h. moving to the left as indicated by “12 L” and there is a 3-mph tailwind as indicated by the plus sign in “3+”. FIG. 14B further includes indicators of a steady state of optimum wind, namely the green indicator 924, yellow indicator 926, and red indicator 928, as described above.

FIGS. 14A through 14B are based on the crosswind vector 52 and tailwind vector 56 in relation to the wind 48 relative to the path to the targets (see FIG. 13).

The handheld portable use and operation of trained AI device 10 is now discussed in more detail.

In operation, the user aligns AI device 10 with the target T and views the target T on the display 30. The AI device 10 may provide generally conventional optical functionality, such as magnification or other optical modification, by utilizing a lens 24 and/or the computing element 16. Preferably, the device 10 provides an increased field of vision as compared to conventional riflescopes to facilitate conventional view functionality. The focal magnification typically is 4×, 5×, 7×, 12× and so forth. In some embodiments the magnification factor is variable, such as with a zoom feature. This magnification value is used by the computing element 16 in performing the mapping of the various indicators, and operating the deep learning model on the captured image is discussed in reference to FIGS. 10A through 10F above.

Further, the user may function the inputs 32 to control the operation of AI device 10. For example, the user may activate AI device 10, provide configuration information, and/or turn on or off automatic operation, or manually initiate a capture and recognition sequence by functioning one or more of the inputs 32.

### High-Resolution Display Use and Operation

FIGS. 15A and 15B illustrate a high-resolution display 31 showing an aiming point 982 based on a projectile trajectory path adjusted for wind using the deep learning model of the present invention. The crosshairs 900 are used to aim the AI device 10 towards the target (deer 90), providing an input to the deep learning model the direction of the line of sight to the target. It also displays the captured image 36 for recognizing current wind (as shown in FIG. 10B).

FIGS. 15A and 15B each shows a high-resolution display 31 providing digital video superimposed with horizontal distance indicator 914, crosswind indicator 922, and adjusted aiming point 982. The adjusted aiming point 982, in this embodiment, doubles as the green indicator 924.

FIG. 15A shows an output from the deep learning model. There is an 8-mph cross wind moving left and a 1-mph headwind. The user is guided to shoot for 280 yards at the dynamically moving adjusted aiming point 982 when it turns green.

FIG. 15B shows an output from the deep learning model after the wind has shifted. There is a 3-mph cross wind moving right and a 3-mph tailwind. Accordingly, the user is guided to shoot for a shorter distance of 278 yards at the dynamically moving adjusted aiming point 982 when it turns green.

FIG. 15C shows yet another embodiment where green indicator 924 is in a permanent position near the center of the user's field of vision. The wind is much stronger. There is an 18-mph cross wind moving left and a 10-mph headwind. Accordingly, the user is guided to shoot for a longer distance of 285 yards at the dynamically moving adjusted aiming point 982, when the separate green indicator 924 is illuminated.

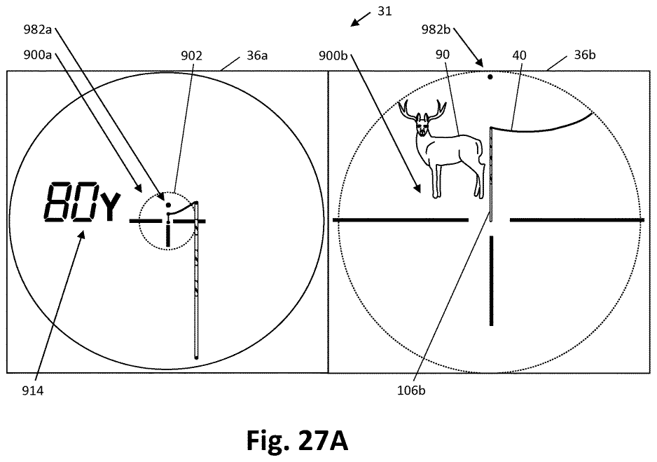

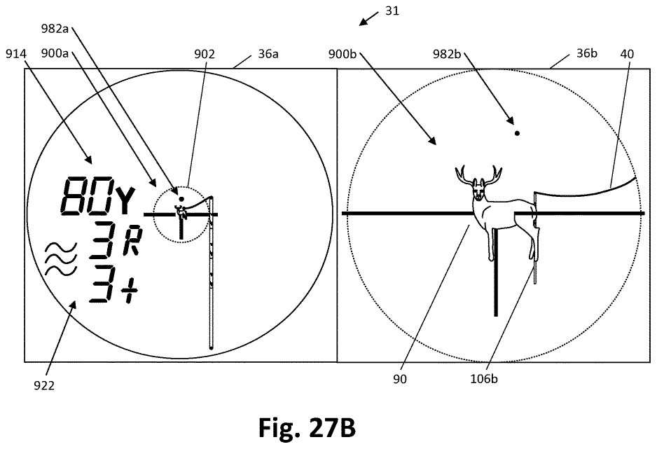

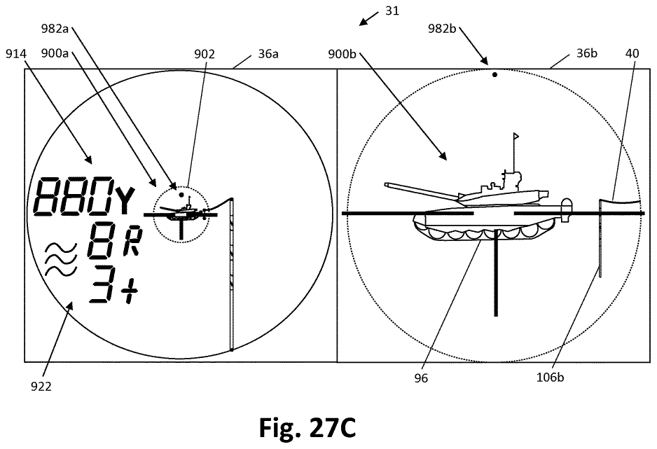

See discussion of FIG. 27 below.

### High-Resolution Digital Display

FIG. 16 shows a high-resolution display 31 providing digital video superimposed with crosshair 900, horizontal distance indicator 914, crosswind indicator 922, and adjusted aiming point 982. The adjusted aiming point 982, in this embodiment, can double as the green indicator 924. This embodiment has very simple use for the operator, for example, the text on the screen simply states, “There is a left crosswind at 18 m.p.h. and a 10 m.p.h. headwind. Shoot for 285 yards at the aiming point displayed above when it is green,” or even simpler “Aim at the dot and shot when it turns green.”

This simple embodiment is an example of our best mode embodiment which we intend to market under the AimFinder™ trademark.

FIG. 16 shows a digital, high-resolution display 31, in this example, a touch screen display of an Apple iphone 11.

One advantage of a digital, high-resolution display 31 is that it is not limited to the circular optical focus area. The additional area of the rectangular display can be used for various purposes. Information can be moved outside the circular focus area, for example, to the lower corners and bottom of the screen. This has the advantage of allowing the circular focus area to be less cluttered and to obscure less of the optical image information. Further, the rectangular high-resolution display 31 can provide more optical information.

Another advantage of a high-resolution display 31 is that the overlay information is produced by software rather than by a hardware chip. Custom hardware chips can be expensive to design and manufacture and are less flexible. The overlay information generated by software for display on the high-resolution display 31 is higher quality, such as easier to read fonts, and move flexible, such as being able to display in different colors or locations of the screen to avoid obscuring the optical information being overlaid. The display can have more options, such as natural languages, different number systems such as Chinese, different units of measure, and so forth. Further, the software can be easily updated to incorporate new features, to improve calculations, or to support addition projectile information. Updates can be made in the field as well as in new models at a lower cost. For example, in some embodiments, new software can be downloaded over the Internet.

### High-Resolution Touch Screen Display

FIG. 16 also shows an exemplary touch screen display as an embodiment of the high-resolution display 31. The high-resolution display 31 displays the video image as digitally captured by the digital camera 25 (see FIGS. 3 and 4).

The embodiment shown comprises a mobile smart phone, in particular an Apple iphone 11. Correlating FIG. 3 and FIG. 20 with FIG. 16, the computing element 16 is the processor of the iPhone 11; the memory 18 is the memory of the iphone 11; a 9-axis sensor 15 is the 3-axis magnetic compass, 3-axis gyroscope, and 3-axis accelerometer of the iPhone 11; and the display 30 is the touch screen display of the iphone 11, an embodiment of the high-resolution display 31.

### Digital AI Devices

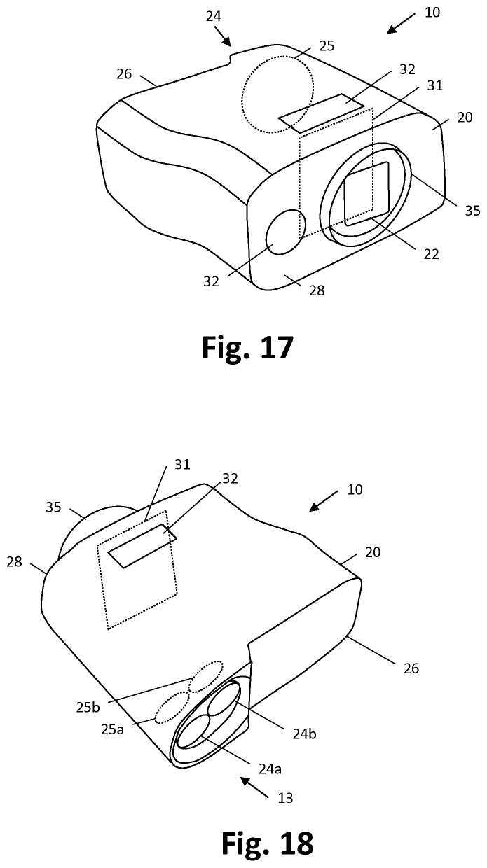

FIGS. 17 and 18 are rear and front perspective views, respectively, of digital embodiments of AI device 10.

The digital AI device 10 comprise a housing 20, having an eyepiece 22 at the proximate end 28, a lens 24, an optional range sensor 13 (FIG. 20), and inputs 32 in various places on exterior. In contrast to the conventional rangefinder, the housing 20 contains an image sensor (digital camera) 25 that captures and digitizes video from the optical image through the lens 24 and contains a digital, high-resolution display 31. The video comprises a series of image frames. The computing element 16 (FIG. 3) processes the image frames, overlays each frame with various indicators, and displays the resulting image on the high-resolution display 31. Further, the high-resolution display 31 is controlled completely by the computing element 16 (FIG. 3) and need not display any of the optical image being captured; instead, the high-resolution display 31 may display setup menus, recorded video, or annotations generated by the computing element 16 (FIG. 3).

FIG. 17 shows at least one lens 24 and at least one image sensor 25.

FIG. 18 shows an embodiment with two lens 24, namely, a low magnification lens 24a and a high magnification lens 24b; and two digital camera image sensors 25, namely, a low magnification image sensor 25a and a high magnification, preferably higher resolution, image sensor 26b. The low magnification lens 24a is in the range between 4× and 12×. The high magnification lens 24b is in a range greater that 20×, and preferrable would provide pixel detail of a target object at a distance between 400 yards and 1000 yards.

The eyepiece 22 may also be modified to accommodate viewing of the high-resolution display 31. In particular, the eyepiece 22 may be inset and be protected by a shroud 35.

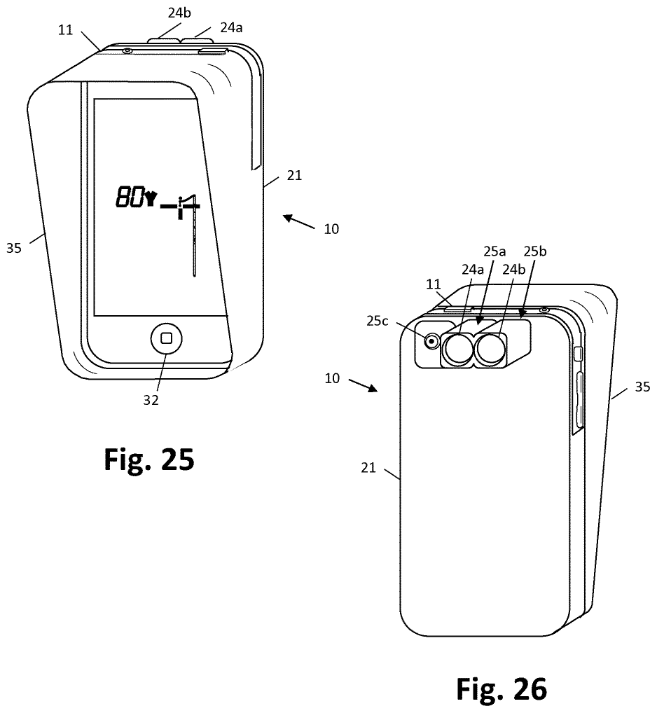

Smartphone based embodiments are discussed below regarding FIGS. 25 and 26.

In contrast to the conventional rangefinder housing 20 as shown in FIGS. 14 and 15, the housing 20 of the digital rangefinder of FIGS. 17 and 18 is more compact, more lightweight, and easier to transport and use, due to removal of the end-to-end optics, and the optional removal of the laser related electronic components and lenses. For example, the length between the proximate end 28 and the distal end 26 is shown as less than about four inches. The width and height could be about two inches, respectively.

### AI Devices Comprising Mobile Smart Phones and Tablets

In addition to the AI advantages of the present invention, embodiments comprising mobile smart devices, such as iPhone 11 or Android (e.g., Samsung, LG, Lenovo, Amazon, etc.) have several advantages over conventional rangefinders. First, the user has one less item to carry this reduces the overall weight and complexity. Second the range finding device has a lower incremental cost to manufacture, being just the alternate housing 21 (FIG. 25 and FIG. 26) and the range sensing means 13 (FIG. 20). The processor (computing element 16), 9-axis sensor 15, digital camera 25, high-resolution display 31, and inputs 32 (including touch screen display inputs 34) of the mobile smart device is used to provide the necessary components of the digital rangefinder device10. Third, the mobile smart device, such as iPhone 11, has other useful features such as global positioning system (GPS), virtual maps, satellite images, emergency communications, video capture, video playback, digital photographs, etc.

Advantages of mobile smart device are explained with an exemplary scenario. The user uses the GPS and satellite images to travel to a hunting spot identified on a previous trip; however, the topographical maps and satellite images allowed the user to find a more direct, shorter route. A group of targets are in thick brush. Zoom video is taken showing the details of the targets such as which are does and bucks, number of points on the antlers, size of the animals. The dynamic clear shot trajectory mode is used to identify potential obstacles and to position the user and the weapon for a clear shot. The photo is marked with the GPS coordinates and time. The photo image may be uploaded to the deep learning training dataset. A second video is captured showing an animated projectile trajectory 2 path from a straight view. The motion sensors of the iphone 11 are used to determine any projectile inertia. A third video is captured showing the animated projectile trajectory 2 path from a side perspective view. The firing device is aimed based on the information provided by AI device 10. When the projectile is fired, a fourth video is captured showing the actual projectile trajectory 2 and the success of failure of the shot. The success of the AI device prediction is scored. If Internet access is available via WiFi or via cellular wireless, the photo and videos can be uploaded to friends, video producers, or social networking sites, as well as deep learning training dataset. Any of the videos can be replayed.

In yet another more sophisticated embodiment of a very smart rangefinder device 10, an analysis of the second video can be compared to an analysis of the fourth video and AI device 10 can automatically recalibrate to match the true trajectory captured in the fourth video. The true parabola values, the air drag, and the crosswind drift can be determined and used for developing a training set for a future embodiment.

### Complex Harsh Natural Environments

FIG. 19 illustrates a string 40 and flexible rods 106a and 106b placed in a harsh, rough environment with hills and valleys and strong winds at different speeds and directions along the projectile trajectory path. The terrain causes different wind represented by wind 48a, 48b, and 48c. Wind 48a is illustrated going up the near hill toward the target T. Wind 48b is shown as an opposing cross wind moving right along the valley and adjacent cliff. Wind 48c is shown with a right crosswind and a slight headwind from wind coming over the taller mount crest.

The reader will see that the fiducial points 38a through 38h is a more complex curve. Such a curve may be too difficult for a human to interpret in a short enough time to make an ethical shot. However, the present invention (AI device 10) provides the possibility of rapid accurate analysis faster than a human.

### Improved Laser-Less, No Emission Range Finder

FIG. 20 illustrates our novel AI device 10 comprises a computing element 16, coupled with a range sensing means 13, a 9-axis sensor 15, a memory 18, wireless communications 19, and a display 30, which is preferably a high-resolution display 31. A housing 20 contains the elements of the device 10.

The 9-axis sensor 15 combines a 3-axis gyroscope, 3-axis accelerometer and 3-axis compass in the same chip together. The gyroscope provides immediate response to changes in orientation but suffers from drift over time. The compass provides accurate magnetic direction but may be slow to respond and may be affected by aberrations in the magnetic field such as metal structures. The software running on the computing element 16 corrects for the deficiencies in each different 3-axis sensor. This is known as software fusion. These sensors provide information to the AI device 10 to make fine adjustments to the projectile trajectory.

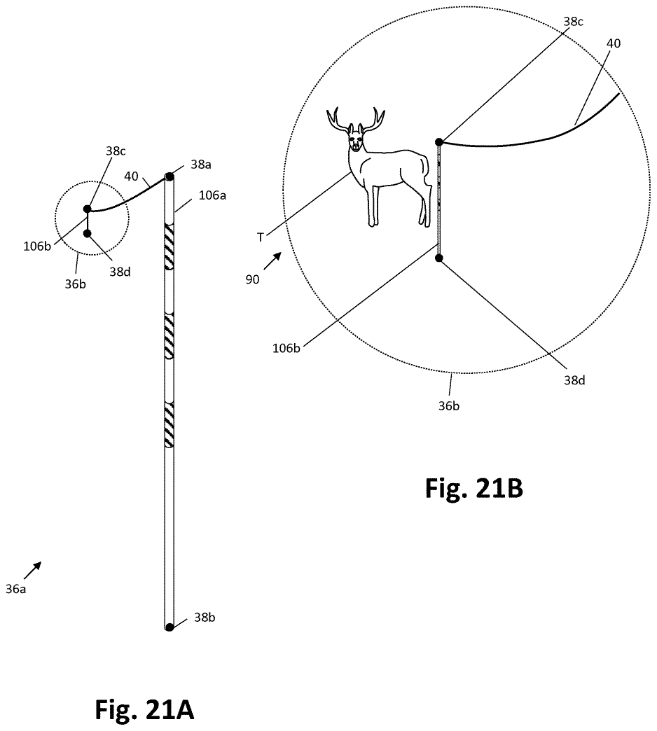

In laser-less embodiments, the range sensing means 13 comprises one or more digital cameras 25 providing a magnified digital image 36 (e.g., FIG. 10B, FIG. 21A, and FIG. 21B) to the AI running in on the computing element 16 and using memory 18.

### Determining Distance Between Rods

FIG. 21A illustrates a string 40 and flexible rods 106a and 106b. In this illustration both rods are five feet tall. The near rod 106a is about 6 feet from the AI device 10. The far rod 106b is 80 yards past the near rod 106a. The string 40 is 80 yards long. The near rod 106a has been detected and is displayed with top fiducial point 38a and bottom fiducial point 38b measuring a size of 60 inches (5 feet) between the top and bottom of the rod. The far rod 106 has been detected and is displayed with top fiducial point 38c and bottom fiducial point 38d measuring a size of 60 inches (5 feet) between the top and bottom of the rod.

The distance between the rods, impacts the weight of the string and the images being analyzed to determine wind.

### Low Magnification Aiming Image and High Magnification Recognition Image

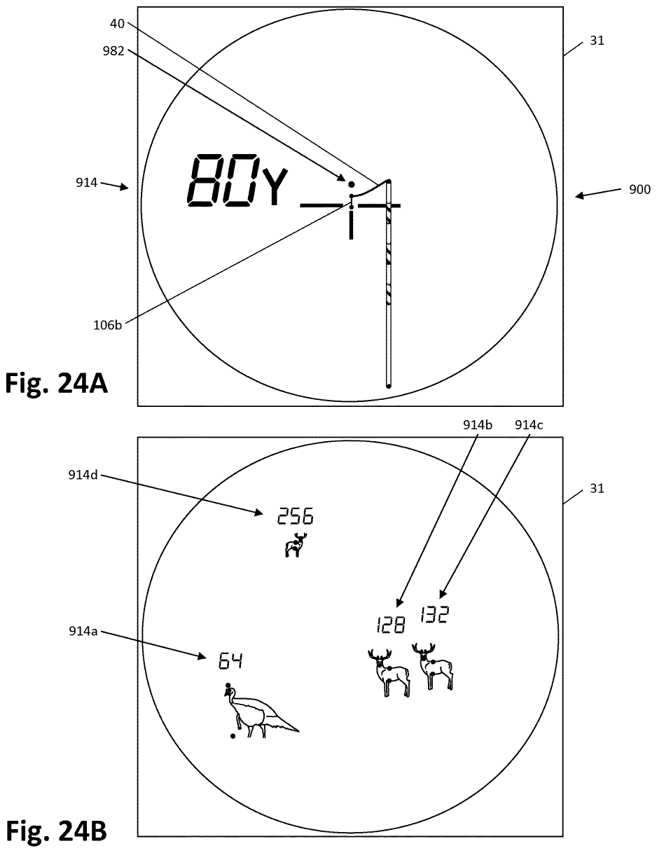

In a preferred embodiment at least one digital camera 25a (FIG. 18) provides a low magnification image 36a (e.g., FIG. 21A and FIG. 24A) which aids the user in locating the desired target and aiming the device 10 crosshairs 900 (FIG. 24A) and another digital camera 25b (FIG. 18) provides a high magnification image 36b (FIG. 21B) which aids the AI device 10 in determining an accurate size by having greater pixel resolution in the image,

As shown in FIG. 21B, more detail of the object being recognized for size are shown in the high magnification image 36b. In this example, the banding on the far rod 106b is better visualized. The AI device 10 can better determine the size by determining the number of pixels in each 6-inch band, as well as the entire 5-foot rod, and averaging the relative results. Further, in this example, the deer 90 target T which was lost in the fog in the low magnification image 36a is now visualized in the high magnification image 36b. The AI device can also recognize a height for the deer 90 based on its known back to brisket size of 17 inches, and can compare it to the known size of the 5-foot rod, to determine a more precise range to the target T.

### Detecting Objects in an Image

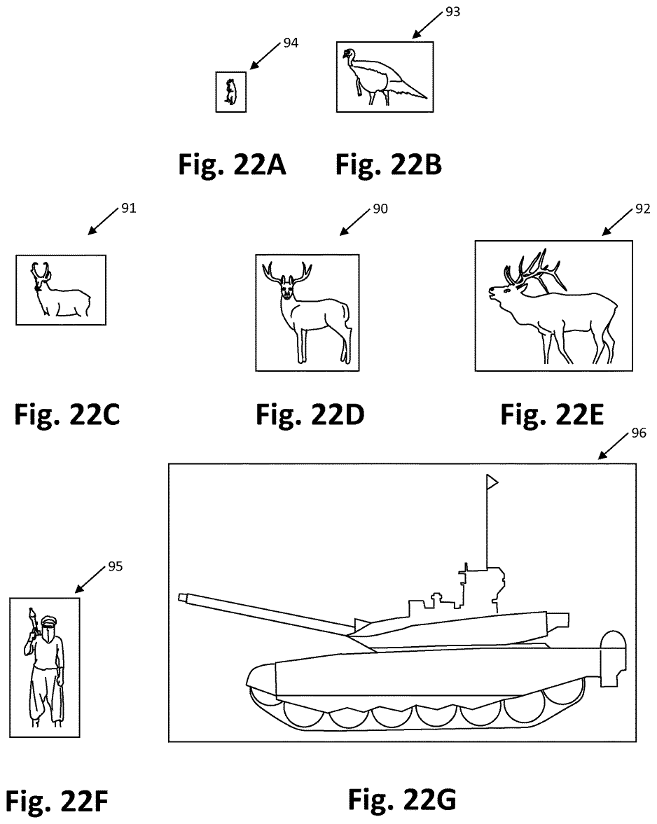

FIGS. 22A through 22G show different detected objects. During initial detection, different objects in the image being analyzed are detected and four points defining a bounding rectangle containing each object are identified. The bounding rectangle is used to crop the image before further analysis and alignment.

FIG. 22A shows a ground hog 94 detected and shown in a bounding rectangle.

FIG. 22B shows a turkey 93 detected and shown in a bounding rectangle.

FIG. 22C shows an antelope 91detected and shown in a bounding rectangle.

FIG. 22D shows a deer 90 detected and shown in a bounding rectangle.

FIG. 22E shows an elk 92 detected and shown in a bounding rectangle.

FIG. 22F shows a man 95 detected and shown in a bounding rectangle.

FIG. 22G shows a tank 96 detected and shown in a bounding rectangle.

### Using Known Sizes to Determine Distance

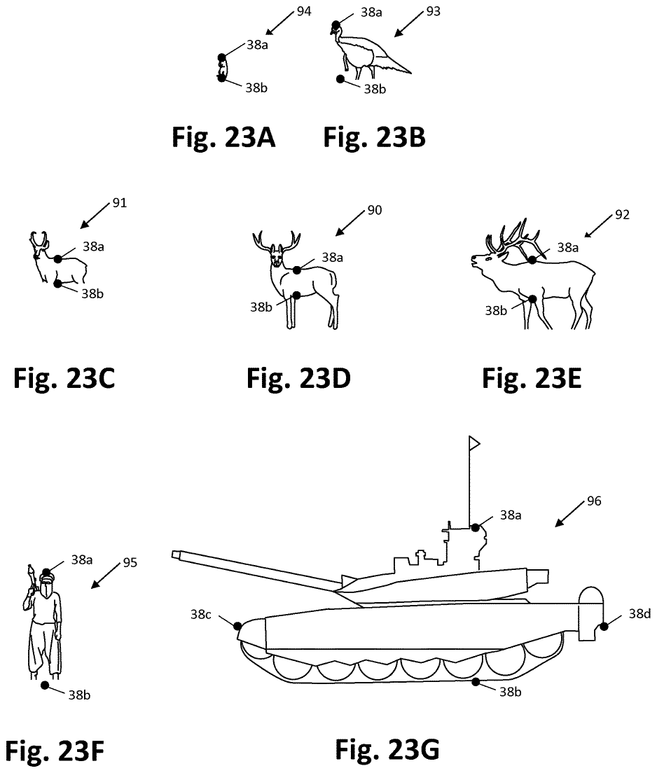

FIGS. 23A through 23G show the different detected objects (see FIGS. 22A through 22G, respectively). Each cropped image may be further analyzed to determine what kind of object it contains, e.g., a man; a vehicle, such as a truck or a tank; a four-legged mammal, such as a deer; a bird, such as a turkey, etc. Once the type of object is generally determined, fiducial points are identified that provide a measure, e.g., in pixels, of at least two points for that type of object. Each figure shows a height that is determined between a top fiducial point 38a and a bottom fiducial point 38b. The fiducial points may also be used to align the image. The cropped image may be analyzed further (as discussed below) to perform more specific identification of the object, such as the model of vehicle or the species, gender, and maturity of mammal.

FIG. 23A shows a ground hog 94 with top fiducial point 38a and bottom fiducial point 38b estimating a size of 16 inches between the top of the head and the feet.

FIG. 23B shows a turkey 93 with top fiducial point 38a and bottom fiducial point 38b estimating a size of 36 inches between the top of the head and the feet.

FIG. 23C shows an antelope 91 with top fiducial point 38a and bottom fiducial point 38b estimating a size of 15 inches between the top of the back and the bottom of the chest (or brisket).

FIG. 23D shows a deer 90 with top fiducial point 38a and bottom fiducial point 38b estimating a size of 20 inches between the top of the back and the bottom of the chest (or brisket).

FIG. 23E shows an elk 92 with top fiducial point 38a and bottom fiducial point 38b estimating a size of 27 inches between the top of the back and the bottom of the chest (or brisket).

FIG. 23F shows a man 95 with top fiducial point 38a and bottom fiducial point 38b estimating a size of 69 inches between the top of the head and the feet.

FIG. 23G shows a tank 96 with top fiducial point 38a and bottom fiducial point 38b estimating a size of 98 inches between the top of the turret and the bottom of the tread.

Each of these objects have a generally well-known size. The AI device 10 is set with a known magnification for each input camera and lens and a pixel height and width for each image. The AI device 10 calculates a preliminary distance based on measured number of pixels in the image and the generally known size (e.g., 20 inches between the top of the back and the bottom of the chest or brisket). In our calculations A is the known height in yards 20 inches=0.556 yards for a deer, and A is 2.6 yards for a Abrams tank.

For an iPhone 14 Pro, we determined an angular distance scale factor B of 2855 pixels per radian. Pixels per radian is calculated by dividing the pixel width of the sensor by 2 times the arctan of the sensor width in mm divided by 2 times the focal length in mm. The sensor in the iPhone 14 is 4030×3024 in pixels for still images, or approximately 9.9 mm wide by 7.3 mm high. The focal length is 24 mm.

The range is calculated with the equation range=A/(2 tan (y/2*B), where y is the object height in pixels.

### Displaying a Determined Distance

Once the distance is determined, the preliminary distance is displayed numerically superimposed over the image from the camera.

FIG. 24A illustrates a high-resolution display 31 showing an aiming point 982 based on a projectile trajectory path adjusted for range determined by detecting and measuring objects of known size. The crosshairs 900 are used to aim the AI device 10 towards the target, in this case the far rod 106b. It also displays the captured image, in this case the string 40 and the two rods 106, and their fiducial points (see FIG. 21). The range is calculated by analyzing the number of pixels in the height of the far rod 106b (FIG. 21). The range may be adjusted for shooting angle. The range of 80 yards is displayed in the horizontal distance indicator 914. Thus, range is determined without using any emission from the AI device 10, resulting in a laser-less handheld rangefinder.

FIG. 24B illustrates a high-resolution display 31 showing ranges superimposed over each detected object of known size. In this advanced embodiment, there is no need for crosshairs. The user simple aims the lens of the AI device 10 in the general direction of interest and each detected object is analyzed to determine its distance. The display 31 shows the captured image, along with fiducial points indicating that the object was detected and measured. The range is calculated by analyzing the number of pixels in the height of each object (see e.g., FIGS. 23A through 23G). The range of each detected objects is displayed over each object. Thus, range to multiple objects is determined without using any emission from the AI device 10, resulting in a enhanced, laser-less handheld rangefinder.

In this example, the turkey's distant 914a is shown as 64 yards, the first deer's distance 914b is shown as 128 yards, the second deer's distance 914c is shown as 132 yards, and the third deer's distance 914d is shown as 256 yards.

### More Precise Classification and Distance Determination

After each object is detected, and its type is determined, the cropped or aligned-and-cropped image may optionally be passed to the AI device for further classification by a deep learning model. For example, the AI device 10 may further identify the specific model of the tank, e.g., an Abrams tank, or a Challenger 1 tank versus a Challenger 2 tank. The AI device 10 may further identify the specific model of a drone, e.g., a Lancet-3 (with a known length of 5′ 5″), a Shahed-136 (with a known wingspan of 2.5 meters) or a Ukrjet UJ-22 (with a known 5-meter wing length). Once the specific model of tank is determined a more specific known height is used to refine the distance calculation. In the case of a deer, the AI device 10 may further classify the dear as a white tail deer, a black tail deer, or a mule deer. A mule deer will have a large known size from top of the back to the brisket of 20 to 24 inches. Once the deer is classified, the range to the deer is updated to provide a more accurate range. The AI device 10 may also classify the deer as a buck (male) or a doe (female) or as a juvenile and similarly provide a more accurate distance or range.

### Smart Phone AI Range Finding Devices

FIGS. 25 and 26 are rear and front perspective views, respectively, of digital embodiments of AI device 10 using a smart phone 11 with additional and lens 24 and digital cameras 25 mounted on a case with a shroud 35.

The smartphone-based rangefinder AI device 10 comprise an alternative housing 21, having a low magnification lens 24a, a high magnification lens 24b, a low magnification image sensor 25a, a high magnification image sensor 25b, a conventional camera 25c, and inputs 32 in various places on exterior.

FIG. 25 shows the high-resolution digital display 31, showing the same results as in FIG. 24A.

AI Range Finding Devices with Low and High Magnification Lenses

FIG. 27A through 27C illustrate a high-resolution digital display 31 showing low magnification digital images 36a with crosshair 900a and aiming point 982a side-by-side with high magnification digital images 36b with crosshairs 900b and aiming point 982b.

The low magnification digital image 36a is displayed with a dashed circle showing the magnification outline 902 of the portion of image 36a being simultaneously captured in the high magnification digital image 36b.

The low magnification digital image 36a is displayed with crosshairs 900a and is used to aim the AI device 10, and the high magnification digital image 36b is used to confirm the aim and is used by the deep learning model to determine the final distance to the target.

A low magnification crosshairs 900a is displayed centered in the low magnification digital image 36a, and the adjusted distance is displayed in the horizontal distance indicator 914.

A high magnification crosshairs 900b is displayed centered in the high magnification digital image 36b.

A low magnification aiming point 982a is displayed over the crosshairs 900a.

A high magnification aiming point 982b is displayed over the crosshairs 900b.

In FIG. 27A, as discussed above regarding FIG. 21B, the crosshairs 900 are aimed at the 5-foot rod 106b supporting string 40. AI device 10 can better determine the size by determining the number of pixels in each 6-inch band, as well as the entire 5-foot rod, and averaging the relative results. In this example, the deer was lost in the fog in the low magnification image 36a and thus was not the target. However, with the high magnification digital image 36b, the user can visualize the deer 90 and re-aim the AI device so that the range to the deer can be recognized. The horizontal distance indicator 914 shows the rod 106b at a range of 80 yards.

In FIG. 27B, crosshairs 900b are now used to aim at the deer 90. The horizontal distance indicator 914 shows the deer 90 at a range of 80 yards. The DeepWind™ technology (disclosed in the grandparent application) which recognized the string 40 in FIG. 27A, has determined a 3 m.p.h. crosswind and a 3 m.p.h. tail wind as shown in the crosswind indicator 922.

In FIG. 27C, crosshairs 900b are now used to aim at a tank 96. The horizontal distance indicator 914shows the tank 96 at a range of 880 yards. The DeepWind™ technology has determined an 8 m.p.h. crosswind and a 3 m.p.h. tail wind as shown in the crosswind indicator 922. The magnification of the high magnification digital images 36b in FIG. 27C is greater than shown in 27B.

The display of FIG. 27A through 27C is our currently preferred best mode embodiment which we intend to market under the AimFinder™ trademark with DeepRange™ technology.

Faster Range Detection after Initial Object Type Determination

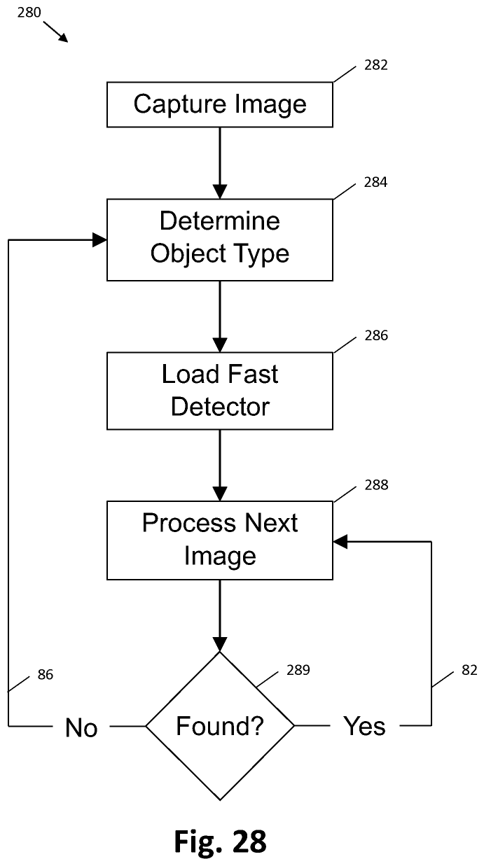

FIG. 28 illustrates a method of determining object type with a slower detector and then loading a fast detector based on the determined object type to process and identify ranges in subsequent images that contain the determined object type.

While neural network object detection and classification can be more accurate than algorithmic object detection, it requires significantly more computing power and time. We determined that in many situations the user is interested in one type of object and once the type of object is confirmed the speed of the ranging of subsequent images is more important than continued accuracy.

For example, a hunter may only have a tag to hunt for a deer and will go to an area where deer are believed to be. Once the first deer is seen, the AI device can capture an image and confirm the specific classification of the deer. It can determine object type equal deer, gender equal male, and maturity equal adult. Once that classification is made for the first group of deer, we determined we can use a faster detector to determine the distance in each subsequent image that contains a deer.

In a military example, a war fighter may be in a battlefield where there is only one make and model of tank as targets. Once the first tank is seen, the AI device can capture an image and confirm the specific classification of the tank. It can determine object type equal tank, make equal Uralvagonzavod, and model equal T-72. Once that classification is made for the first group of tanks, we determined we can use a faster detector to determine the distance in each subsequent image that contains a tank.

FIG. 28 illustrates the steps of a fast detection method 280. The first step is the capture image 282 step where an image is captured. Next the in determine object type 284 step a slower object detector and/or object detector is used to accurately determine the object type and an accurate known size of the object found in the image. The AI device may display the object type to the user for confirmation, e.g. as a mature white tail buck or as a Uralvagonzavod T-72 tank. Next, after the object type and/or classification is determined, a faster executing detector, such as an algorithmic object detector (e.g. Viola-Jones, HOG, SVM, SSD) or faster CNN (e.g. YOLO), is loaded in a load fast detector 286 step. After the faster detector is loaded, in the process next image 288 step a new image is captured, an object is detected, and the known size is used to determine the current range to the object. If no object of the object type is found, at the found 289 decision, the no path 86 is followed and the slower object type detection is repeated. If found, the yes path 82 is followed, to process the next image.

The fast detection method 280 provides significant improved range detection performance and uses less power. This method enables for a handheld device to be used in the field, e.g. while hunting or war fighting, while requiring less power and/or weight.

### Using a Plurality of Object Detectors to Determine an Initial Object Type

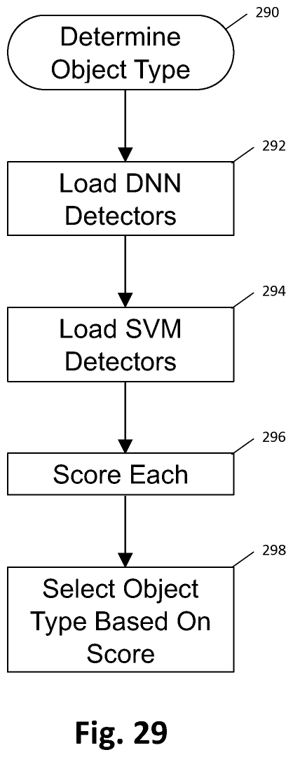

FIG. 29 illustrates details of an embodiment of a method of determining object type by loading a plurality of detectors and scoring the results of each detector. Over time we trained various DNN and SVM detectors to be very good at identifying a specific species of animal or a specific make and model of tank. Each detector would provide a score of how likely an object in an image was the species or make and model for which we had trained.

FIG. 29 illustrates an embodiment of the determine object type 284 step shown in FIG. 28. This embodiment is optional as other methods can be used in the fast detection method 280 of FIG. 28.

FIG. 29 illustrates an embodiment of a determine object type method 290, in the first two steps a plurality of object specific detectors is optionally loaded. In a load DNN detectors 292 step a plurality of DNN based object detectors are loaded. In a load SVM detectors 294 step load a plurality of algorithmic object detectors are loaded. For example, we could load a SVM white tail deer detector, an SVM elk detector, and CNN vehicle detector, which can detect tanks and trucks. The first two steps are optional, and order is not important. In a score each detector 296 step, the current image is input to each detector and score of each detector is recorded. An object type is selected based on the detector that gave the highest score in the select object type based on score 298 step.

In another embodiment, a small number of frames of video are captured and the collection of loaded detectors are run on each of the frames. The scores are compared across the frames, and the highest composite score is used to determine the object type.

### Highlighting Desired Targets

In some embodiments, only desired targets such as a mature white tail buck or as an enemy Uralvagonzavod T-72 tank are highlighted, e.g. with a bounding box and a range.

In other embodiments, desired targets are highlight with a different bounding box style. The style could comprise different color, different line or dot thickness, or different shape. The different highlight makes the desired target stand out among other detected objects.

### Lightweight, Low Power Handheld AI Devices

For both hunting and foot mobile warfighting environments, having a lightweight, low power consuming handheld AI device provides several benefits of ease of transporting and ease of use in the field.

In some embodiments, the emission-less range finding device can be implemented having an optical path and a reflected segment display e.g. LCD or OLED, similar to current products, such as Leupold RX-FullDraw 5 and RX-1400i True Ballistic Range/Wind (TBR/W) Gen 2, wherein the current laser range sensor is replaced with laser-less, no emission range sensor, such as an image analysis range determining method. Battery power no longer needed for the laser and the ranging finding sensor could be applied to the image analysis.

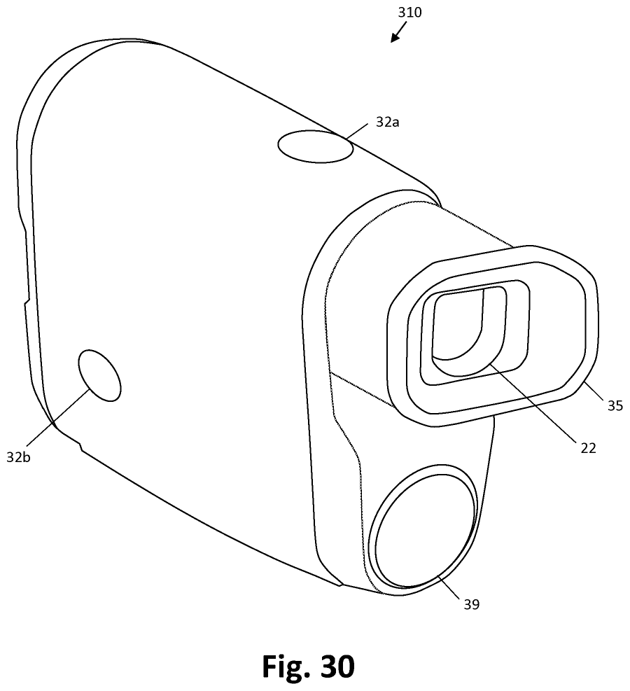

In another embodiment, FIG. 30 illustrates a high-resolution AI device 310 having a high-resolution digital display 31 (internal) viewed through an eyepiece 22. In both hunting and foot mobile warfighting environments, it is important that the high-resolution AI device 310 does not light up the face or body of the user. In this preferred embodiment, the eyepiece 22 is shielded against stray light by a visor or shroud 35. The shroud 35 also is a barrier for comfort, improving image contrast by blocking peripheral light from entering the eye and acts as a barrier for moisture, dust, and maintaining proper eye relief for better focus. The high-resolution AI device 310 is shown with a battery compartment 39 which could receive either conventional or rechargeable batteries. The high-resolution AI device 310 also comprises inputs 32, shown with an operation button 32a and a mode button 32b.

### Deep Convolutional Neural Network

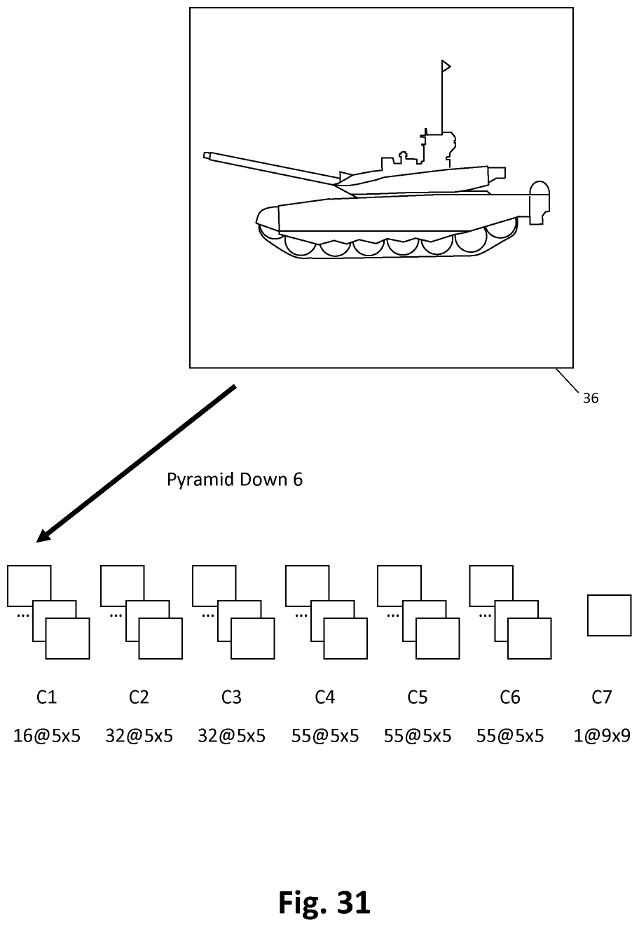

FIG. 31 illustrates a deep convolutional neural network that was used in our tank detector.

Deep CNNs are described in papers including Gradient-based learning applied to document recognition by LeCun, Yann, et al. and Max-Margin Object Detection by Davis E. King. Source code for a vehicle detector using max-margin object detection is available as part of the dlib library at https://dlib.net/ml.html#loss_mmod_.

FIG. 31 shows an image 36 of a tank. The image 36 is downscaled to create six different layers of an image pyramid. Each layer is scaled by a factor of ⅚^{th} resulting is slightly smaller images which helps the AI achieve scale invariance.

The first convolutional layer C1 of the deep CNN illustrated in FIG. 31 receives the image pyramid as input. Convolutional layer 1 C1 has 16 feature maps, each with a size of 5×5 (notated as 16@5×5). Each feature map is fed into the next layer as a channel. Convolutional layer 2 C2 and convolutional layer 3 C3 each have 32 feature maps, each with a size of 5×5 (notated as 32@5×5). Convolutional layer 4 C4, convolutional layer 5 C5, and convolutional layer 6 C6 each have 55 feature maps, each with a size of 5×5 (notated as 55@5×5). The final convolutional layer 7 C7 has one feature map with a size of 9×9. ReLU is applied to each layer except the final convolutional layer 7 C7.

Deer Models with Six Fiduciary Points

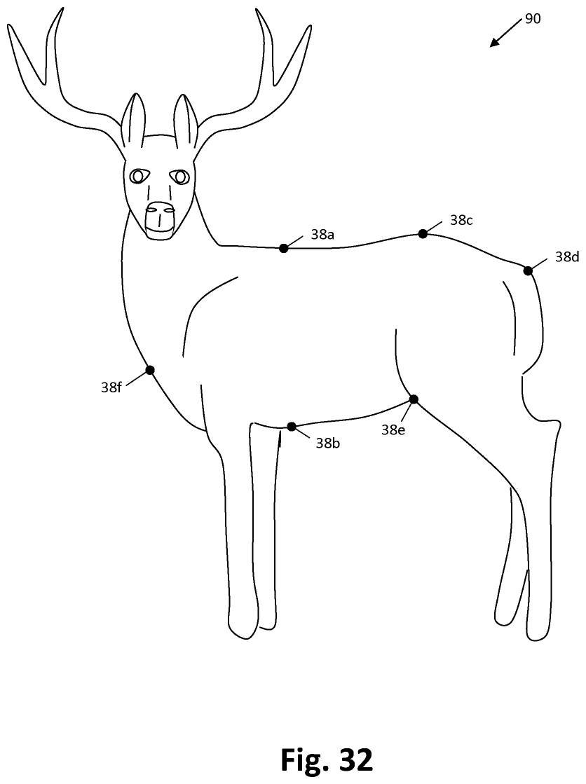

FIG. 32 illustrates a deer 90 with six fiduciary points 38a-f. Fiduciary point 38a identifies the high point of the back of the deer 90 above its heart and lungs. Fiduciary point 38b identifies the brisket of the deer 90 below its heart. When aligned the pixel difference between the y values of fiduciary points 38b and 38a provide the chest height of the deer 90 in pixels. For a mature white tail buck, this would represent about 20 inches. If not aligned, the hypotenuse between the fiduciary points 38b and 38a would provide the chest height in pixels.

Other fiduciary point pairs could be used to provide known measurement which could be used instead of chest height, or which could be used to provide a sanity check to the calculated chest height. For example, the distance between fiduciary points 38c and 38e should be slightly smaller than the chest height, or about 19 inches. Horizontal measurements could also be taken from an image. For example, the fiducial point 38d on the rump and fiducial point 38f on the front of deer 90 can be used to determine a deer body width which is a little over the twice the deer chest height. These three measurements could be used to calculate three separate range values, which are compared to validate the calculated range before display to the user.

Good results were found when we trained an SVM shape predictor using these six fiduciary points. The model was able to determine the correct points in images where the deer was facing left of right, and even when the deer was in different poses, such as head down eating or looking away.

Good ranging results were found when only the hypotenuse between the fiduciary points 38b and 38a were used in calculations. Range determination was performed in real time, e.g. 30 frames a second without using a deep neural network, as discussed above in reference to FIG. 28.

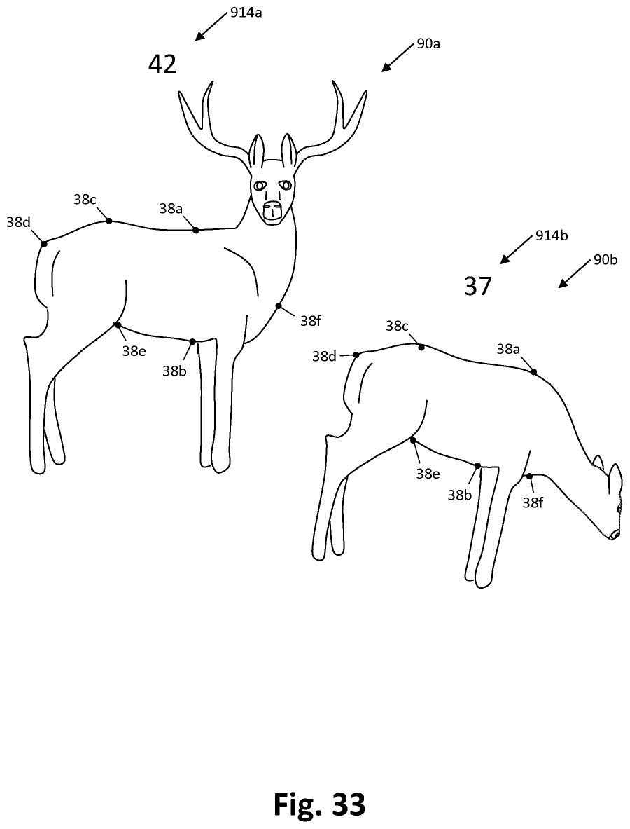

FIG. 33 illustrates a buck (deer 90a) and doe (deer 90b) on a mountain side each with six fiduciary points 38a-f. In this image the buck (deer 90a) is facing the user and has a calculated range 914a of 42 yards. The doe (deer 90b) is closer (calculated range 914b) of 37 yards and is eating grass on a downhill slope. The six fiduciary points 38a-f points are sufficient to perform a 2D alignment of the doe's torso before performing range calculations, or before inputting a cropped aligned image to a deep neural network for more specific classification.

Deer Models with Twenty Fiduciary Points

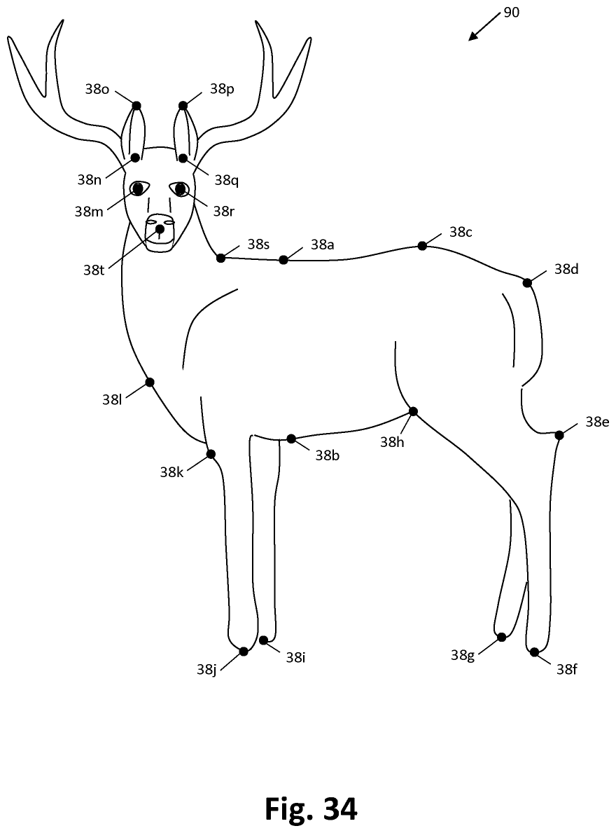

FIG. 34 illustrates a deer 90 with 20 fiduciary points 38a-38t. As in the six point model of FIG. 32, fiduciary point 38a identifies the high point of the back of the deer 90 above its heart and lungs. Fiduciary point 38b identifies the brisket of the deer 90 below its heart. When aligned the pixel difference between the y values of fiduciary points 38b and 38a provide the chest height of the deer 90 in pixels. For a mature white tail buck would represent about 20 inches. If not aligned, the hypotenuse between the fiduciary points 38b and 38a would provide the chest height in pixels.

The additional 18 fiduciary points 38c-38t provide more information and allow for 3D alignment of the deer's torso before performing range calculations, or before inputting a cropped aligned image to a deep neural network for more specific classification.

This 20 fiduciary points model provided input for pose classification, as well as species, gender, and maturity calculations.

Tank Models with Twenty-Two Fiduciary Points

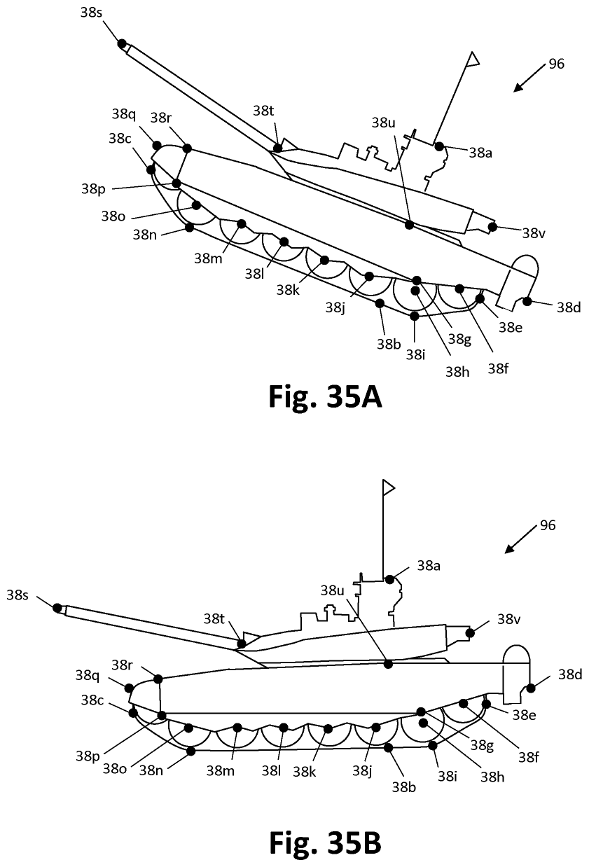

FIG. 35A and FIG. 35B a tank 96 with 22 fiduciary points 38a-38v before and after 2D alignment. FIG. 35A shows the tank 96 in a hill or berm climbing position. FIG. 35B shows the same tank 96 after the 22 fiduciary points 38a-38v have been used to 2D align the image of the tank.

Fiduciary point 38a identifies the high point of the turret section of the tank 96. Fiduciary point 38b identifies the bottom of the tank track below fiduciary point 38a. When aligned the pixel difference between the y values of fiduciary points 38b and 38a provide the height of the tank 96 in pixels. For an Abrams tank, this would represent about 2.6 yards. If not aligned, the hypotenuse between the fiduciary points 38b and 38a would provide the tank height in pixels.

Other fiduciary point pairs could be used to provide known measurement which could be used instead of tank height, or which could be used to provide a sanity check to the calculated tank height. For example, the distance between fiduciary points 38u and 38b would indicate the height of just the low tractor section of the tank 96. Horizontal measurements could also be taken from an image. For example, the fiducial point 38d on the rear and fiducial point 38q on the front of tank 96 can be used to determine a tank body length. These three measurements could be used to calculate three separate range values, which are compared to valid the calculated range before display to the user.

Other fiduciary point groups can be used to provide more accurate information. For example, in this model of tank there are six lower wheels which run on the track. The centers of these wheels (fiduciary points 38h, 38j, 38k, 38l, 38m, and 38o) are equidistance and in a horizontal line. The centers of the wheels are also relatively simple to distinguish in an image. For this model of tank, the measurements between these wheel centers, provide redundant information to validate the range calculations and to accurately guide 3D rotational alignment (e.g. for a quarter facing tank).

### Advantages

### No Laser or Emissions

The AI device provides accurate distance recognition without a laser or other detectable emissions.

### Accurate

The AI device provides for accurate adjustment of aim based on more accurate identification of the height of a known object.

### Effective

Because the AI device provides for accurate adjustment of aim for a range, each shot taken will be more effective.

### Confidence

The AI range information gives the user confidence that the target has been properly identified (e.g., as legal game for which the hunter has a tag) and that a shot can be successfully taken. This increased confidence will improve the user's performance and satisfaction.

### Increased Safety

More accurate aiming increases safety.

### Adjustable

The embodiments of these AI device displays are adjustable to be consistent with an individual user and current type of target, for example, distances could be presented in yards or meters and the object of the current hunt could be set to “Mule Deer.”

### Lightweight

Handheld or portable mounted AI devices are lightweight.

### Easy to Transport and Use

AI devices easy to transport and use.

### Rapid Use

Embodiments that provide an aiming point are used rapidly without having to use brain power to select numbers and estimate an aiming point.

### Lower Power Consumption

Laser-less, no emission embodiments eliminate the power required by laser and laser sensor.

### Conclusion, Ramification, and Scope

Accordingly, the reader will see that the novel laser-less, no emission, range finders provide important information regarding the projectile trajectory path and importantly provide greater accuracy, effectiveness, and safety.

While the above descriptions contain several specifics these should not be construed as limitations on the scope of the invention, but rather as examples of some of the preferred embodiments thereof. Many other variations are possible. The high magnification digital image could be produced by a zoom lens system where the magnification is variable and passed as an input to the distance calculations. The AI device and methods could be applied to military situations where the projectiles are fired from a cannon, tank, ship, or aircraft and where the targets could be moving objects such as helicopters or warfighters. Additionally, the AI device and methods could be applied to golf where in a golf mode the device would indicate range based on the measured size of the flagpole in the hole, provide an aiming point and suggest which golf club would result in a ball trajectory that place the ball nearest the desired hole. The variations could be used without departing from the scope and spirit of the novel features of the present invention.

Accordingly, the scope of the invention should be determined not by the illustrated embodiments, but by the appended claims and their legal equivalents.

1. A system for recognizing distance to a target, the system comprising:
a) a computing element,
b) a memory connected to the computing element,
c) at least one image sensor, connected to the computer element,
d) at least one lens with a known magnification, in the optical path of the image sensor, and
e) a display connected to the computing element,
wherein the image sensor captures a digital image having the known magnification,
wherein the computing element recognizes one or more objects in the magnified digital image, wherein at least one object is determined to be the target,
wherein the computing element recognizes an object type of the target,
wherein the computing element calculates a distance to the target based on a known size of the object type and the known magnification of the digital image, and
wherein the calculated distance is shown on the display.

2. The system of claim 1, further comprising a machine learning model implemented in the computing element and the memory,
whereby the machine learning model determines the object type of the target.

3. The system of claim 2,
wherein the machine learning model comprises an algorithmic model.

4. The system of claim 2,
wherein machine learning model comprises a deep neural network.

5. A method of fast distance detection executing on the system of claim 2, comprising the steps of:
a) capturing a first image using the at least one image sensor,
b) determining the object type of the target,
c) loading a fast detector based on the object type,
d) processing another image using the fast detector to detect the target and to calculate a current distance to the target,
e) returning to step b) when the target of the object type is not found in a current image, and
f) repeating step d) while the target is found in the current image.

6. A method of performing the determining the object type step of the method of claim 5, comprising the steps of:
a) optionally loading deep neural network detectors,
b) optionally loading SVM detectors,
c) scoring each loaded detector using a current image, and
d) selecting the object type based on the score.

7. A laser-less handheld device comprising:
a) a housing enclosing the system of claim 2,
b) an eyepiece connected to the housing for viewing the display,
c) a shroud around the eyepiece, whereby the eyepiece is shielded,
d) a crosshair shown in the display,
e) at least one input button for selecting the target under the crosshair, and
f) a battery compartment for receiving a battery,
whereby the device is used in the field to determine and display the calculated distance to the selected target.

8. The laser-less handheld device of claim 7,
wherein machine learning model determines that the type of the object is a deer,
wherein machine learning model determines the species of the deer,
wherein machine learning model determines that the gender of the deer is a buck,
wherein machine learning model determines that the maturity of the deer is a mature adult,
wherein the machine learning model determines an accurate distance to the deer, and
wherein the deer is highlighted in the display,
whereby the user's focus is directed to the deer and the more accurate distance to the deer.

9. The laser-less handheld device of claim 7,
wherein the machine learning model determines that the type of the object is a tank,
wherein the machine learning model determines the make and model of the tank,
wherein the machine learning model determines an accurate distance to the tank, and
wherein the tank is highlighted in the display,
whereby the user's focus is directed to the tank and the more accurate distance to the tank.

10. A laser-less device, mounted on a vehicle, comprising a housing enclosing the system of claim 2,
wherein the vehicle provides sufficient power to operate the system while executing robust convolutional neural networks for object detection and object classification for a plurality of objects,
whereby the device rapidly and accurately detects and classifies the plurality of objects, and
whereby the device provides accurate distances for each of the plurality of detected objects.

11. The vehicle mounted device of claim 10, wherein at least one of the plurality of objects is a tank,
wherein the machine learning model determines that the type of the object is the tank,
wherein the machine learning model determines the make and model of the tank,
wherein the machine learning model determines an accurate distance to the tank, and
wherein the tank is highlighted in the display,
whereby the user's focus is directed to the tank and the more accurate distance to the tank.

12. The laser-less handheld device of claim 7,
wherein the device recognizes one or more classifications of the target object, the classifications comprising the group of:
a) species of the object,
b) gender of the object, and
c) maturity of the object,
wherein the device computes a more accurate final distance to the target based on the one or more classifications, and
wherein the more accurate final distance is displayed on the display,
whereby the user's is provided the more accurate final distance to the target.

13. The vehicle mounted device of claim 10,
wherein the device recognizes one or more classifications of the target object, the classifications comprising the group of:
a) type of vehicle,
b) model of vehicle, and
c) make of vehicle,
wherein the device computes a more accurate final distance to the target based on the one or more classifications, and
wherein the final distance is displayed on the display,
whereby the user views a more accurate final distance to the vehicle.

14. A laser-less range finding device comprising:
a) a housing enclosing the system of claim 2,
b) a gyroscope and accelerometer for sensing the angle to the target,
wherein the display comprises a shoot-for range indicator,
whereby the display indicates a shoot-for range calculated from the recognized distance adjusted for shooting angle.

15. The laser-less range finding device of claim 14, wherein the display illuminates an aiming point.

16. The laser-less handheld device of claim 7,
wherein the type of object is one of the group of:
a) deer,
b) antelope,
c) elk,
d) turkey, and
e) ground hog,
wherein the memory comprises known heights for each type of object,
whereby user is shown accurate distances while hunting.

17. The laser-less range finding device of claim 14,
wherein a first image sensor is configured with a low magnification lens,
wherein a second image sensor is configured with a high magnification lens,
wherein a low magnification digital image is provided by the first image sensor,
wherein a high magnification digital image is provided by the second image sensor, and
wherein the display is configured to show both the low magnification digital image and the high magnification digital image,
whereby the user views the low magnification digital image to locate a desired target, and
whereby the user uses the high magnification digital image to confirm the desired target and to view the aiming point.

18. The laser-less range finding device of claim 15, wherein the aiming point is adjusted for determined wind direction and speed.

19. The laser-less handheld device of claim 12, wherein the type of object and species is displayed on the display,
whereby the user confirms the accuracy of the type of object and species and the determined final distance.

20. The vehicle mounted device of claim 13, wherein the make and model of vehicle is displayed on the display,
whereby the user confirms the accuracy of the make and model of vehicle and the determined final distance.
